(19) United States
(12) Patent Application Publication
(10) Pub. No.: US 2007/0073745 A1
(43) Pub. Date: Mar. 29, 2007

(54) Similarity metric for semantic profiling

(75) Inventors: Bernard Scott, Tarpon Springs, FL (US); Maksim Timofeyev, Tarpon Springs, FL (US); d'Armond Speers, Trinity, FL (US)

Correspondence Address: BINGHAM MCCUTCHEN LLP, 3000 K STREET, NW, BOX IP, WASHINGTON, DC, 20007, US

(73) Assignee: Applied Linguistics, LLC

(21) Appl. No.: 11/443,213

(22) Filed: May 31, 2006

Related U.S. Application Data
(63) Continuation-in-part of application No. 11/232,898, filed on Sep. 23, 2005.

(51) Int. Cl. G06F 7/00

(52) U.S. Cl. 707/100

(57) ABSTRACT

The method, system, and computer program provides the capability to compute measurements of the similarity between portions of text based on semantic profiles of the text portions. A computer-implemented method of determining similarity between portions of text comprises generating a semantic profile for at least two portions of text, each semantic profile comprising a vector of values and computing a similarity metric representing a similarity between the at least two portions of text using the at least two generated semantic profiles. The semantic profile comprises a vector of information values.

### CROSS-REFERENCE TO RELATED APPLICATIONS

This is a continuation-in-part application of application Ser. No. 11/232,898, filed Sep. 23, 2005.

### BACKGROUND OF THE INVENTION

1. Field of the Invention

The present invention relates to information technology and database management, and more particularly to natural language processing of documents, search queries, and concept-based matching of searches to documents.

2. Description of the Related Art

Information technology, the Internet and the Information Age have created vast libraries of information both formal and informal, such as the compendium of websites accessible on the Internet. While representing vast investments of tremendous potential value, the usefulness of such data depends on its accessibility, which depends upon the ease with which a particularly relevant document can be located, and the ease with which relevant information within a document can be found. Consequently, locating relevant information among and within large volumes of natural language documents (referred to often as text data) is an important problem.

True natural language processing may be provided by semantically profiling documents based upon concepts contained in those documents. Documents may be correlated based upon their conceptual relatedness, to perform searching of documents using a search query consisting of a document or portion of a document, to highlight portions of a returned document that are most relevant to the user's query, to summarize the contents of returned documents, etc.

One important measurement that has many uses in natural language processing is a measurement of the similarity of a portion of text to another portion of text. For example, a measure of similarity is useful in determining whether portions of text relate to similar topics, such as in order to segment a document into sections having different topics. Likewise, there are many ways in which similarity may be determined.

A need arises for a technique that provides the capability to measure similarity of portions of text based on characteristics of the text that relevant to the processing being performed.

### SUMMARY OF THE INVENTION

The present invention provides the capability to compute measurements of the similarity between portions of text based on semantic profiles of the text portions. The semantic profiles are preferably vectors of the information values of the words (semcodes) contained in text portions.

In one embodiment of the present invention, a computer-implemented method of determining similarity between portions of text comprises generating a semantic profile for at least two portions of text, each semantic profile comprising a vector of values and computing a similarity metric representing a similarity between the at least two portions of text using the at least two generated semantic profiles.

In one aspect of the present invention, the semantic profile may comprise a vector of information values. The portion of text may comprise a sentence or a paragraph.

In one aspect of the present invention, the similarity metric may be computed according to:

$$extended cosine similarity metric = \frac{{V}_{1} \cdot {V}_{2}}{‖ {V}_{1} ‖ \times ‖ {V}_{2} ‖} , \\ where ‖ V ‖ = \sqrt{{\sum }_{i = 1}^{n} {x}^{2}} , {V}_{1} \cdot {V}_{2} = {\sum }_{i = 1}^{n} {x}_{i} {y}_{i} ,$$

and x,y are information values of segments.

In one aspect of the present invention, the similarity metric may be computed according to:

$$extended dice similarity metric = \frac{{V}_{1} \cdot {V}_{2}}{( {\sum }_{i = 1}^{n} {x}_{i}^{2} + {\sum }_{i = 1}^{n} {y}_{i}^{2} ) / 2} , \\ and where {V}_{1} \cdot {V}_{2} = {\sum }_{i = 1}^{n} {x}_{i} {y}_{i} ,$$

and x,y are information values of segments.

In one aspect of the present invention, the similarity metric may be computed according to:

$$extended jaccard similarity metric = \frac{{V}_{1} \cdot {V}_{2}}{( {\sum }_{i = 1}^{n} {x}_{i}^{2} + {\sum }_{i = 1}^{n} {y}_{i}^{2} ) - ( {V}_{1} \cdot {V}_{2} )} , \\ where {V}_{1} \cdot {V}_{2} = {\sum }_{i = 1}^{n} {x}_{i} {y}_{i} ,$$

and x,y are information values of segments.

In one aspect of the present invention, the similarity metric may be computed according to:

$$z \text{-} method similarity metric = {\sum }_{i = 1}^{n} ( {a}_{i} + {b}_{i} ) \times {c}_{i} , \\ where {a}_{i} = max ( {x}_{i} , {y}_{i} ) , {b}_{i} = min ( {x}_{i} , {y}_{i} ) , {c}_{i} = \frac{{b}_{i}}{{a}_{i}} ,$$

and x, y are information values. The similarity metric may be further computed according to if (aᵢ+bᵢ)×cᵢ≧aᵢ, then substitute bᵢ for (aᵢ+bᵢ)×cᵢ. The similarity metric may be further computed according to if (aᵢ+bᵢ)×cᵢ≧aᵢ, then substitute

$$\frac{( {a}_{i} + {b}_{i} )}{2}$$

for (aᵢ+bᵢ)×cᵢ.

In one aspect of the present invention, the similarity metric may be computed according to:

$${L}_{1} norm similarity metric = \frac{1}{2} {L}_{1} ( p , q ) ,$$

wherein L₁=Σᵢ|pᵢ−qᵢ|, and wherein p, q are conditional probabilities of information values between two semantic profiles computed as an information value for each semcode in a profile divided by a sum of information values for that profile.

In one aspect of the present invention, the similarity metric may be computed according to:
similarity metric=iv_{sc,d}×idv_{sc},
wherein iv_{sc,d} is an information value of a semcode sc in a document d, and idv_{sc} is a value that a semcode sc has across an entire collection.

### BRIEF DESCRIPTION OF THE DRAWINGS

Further features and advantages of the invention can be ascertained from the following detailed description that is provided in connection with the drawings described below:

FIG. 1 is an exemplary block diagram of a system in which the present invention may be implemented.

FIG. 2 is an exemplary flow diagram of a process of operation of a parser and a profiler, shown in FIG. 1.

FIG. 3 is an exemplary flow diagram of a process of part of speech/grammatical function analysis shown in FIG. 2.

FIG. 4 is an exemplary flow diagram of a process of word sense and feature analysis shown in FIG. 2.

FIG. 5 is an exemplary flow diagram of a process of word sense disambiguation shown in FIG. 2.

FIG. 6 is an exemplary flow diagram of a process of information value generation shown in FIG. 2.

FIG. 7 is an exemplary flow diagram of a process of searching based on a search document.

FIG. 8 is illustrates an example of a structure of a semantic database shown in FIG. 1.

FIG. 9 is an exemplary format of a data structure generated by the parser shown in FIG. 1.

FIG. 10 illustrates an example of the determination and weighting of relationships among senses of terms.

FIG. 11 illustrates an example of a decision table used for word sense disambiguation.

FIG. 12 illustrates an example of a decision table used for word sense disambiguation.

FIG. 13 is an exemplary flow diagram of a process of word sense disambiguation using a co-occurrence matrix.

FIG. 14 illustrates an example of a co-occurrence matrix.

FIG. 15 is an exemplary format of a semantic profile.

FIG. 16 illustrates an example of the parsing of a sentence.

FIG. 17 is an exemplary format of a data structure.

FIG. 18 illustrates an example of weighting parameters that may be set for the process.

FIG. 19 illustrates an example of statistics relating to an input sentence.

FIG. 20 illustrates an example of data retrieved from the semantic database and the profiler.

FIG. 21 illustrates an example of output from a process of determination of the taxonomic relationships among the senses of the words in the exemplary sentence.

FIG. 22 illustrates an example of information included in a semantic profile generated by the profiler.

FIG. 23 illustrates an example of similarity ranking of two documents.

FIG. 24 illustrates an example of similarity ranking of a plurality of documents.

FIG. 25 illustrates an example of a process of text summarization.

FIG. 26 is an exemplary block diagram of a computer system, in which the present invention may be implemented.

FIG. 27 is an exemplary flow diagram of a process of polythematic segmentization.

FIG. 28 is an exemplary flow diagram of a process of polythematic segmentization.

FIG. 29 is an exemplary flow diagram of a process of polythematic segmentization.

### DETAILED DESCRIPTION OF THE PREFERRED EMBODIMENTS

The present invention provides the capability to identify changes in topics within a document, and create a separate semantic profile for each distinct topic. The Polythematic Segmentizer is a software program that divides a document into multiple themes, or topics. To accomplish this it must be able to identify sentence and paragraph breaks, identify the topic from one sentence/paragraph to the next, and detect significant changes in the topic. The output is a set of semantic profiles, one for each distinct topic.

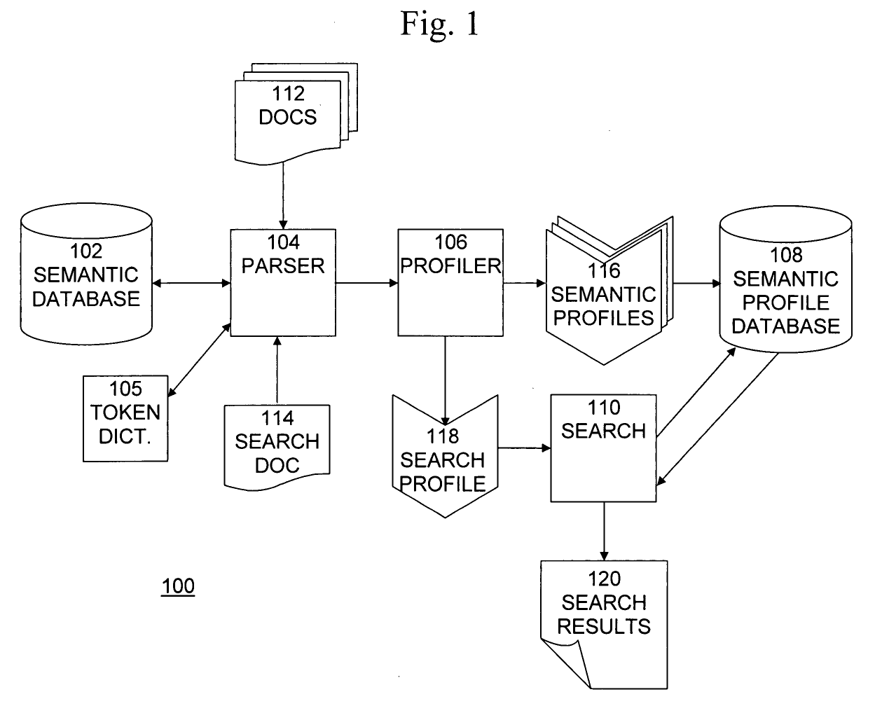

An exemplary block diagram of a system 100 in which the present invention may be implemented is shown in FIG. 1. System 100 includes semantic database 102, parser 104, profiler 106, semantic profile database 108, and search process 110. Semantic database 102 includes a database of words and phrases and associated meanings associated with those words and phrases. Semantic database 102 provides the capability to look up words, word forms, and word senses and obtain one or more meanings that are associated with the words, word forms, and word senses. Parser 104 uses semantic database 102 in order to divide language into components that can be analyzed by profiler 106. For example, parsing a sentence would involve dividing it into words and phrases and identifying the type of each component (e.g., verb, adjective, or noun). The language processed by parser 104 is included in documents, such as documents 112 and search document 114. Parser 104 additionally analyses senses and features of the language components.

Profiler 106 analyzes the language components and generates semantic profiles 116 that represent the meanings of the language of the documents being processed. Semantic profile database 108 stores the generated semantic profiles 116, so that they can be queried. In order to generate semantic profile database 108, language extracted from a corpus of documents 112 is parsed and profiled and the semantic profiles 116 are stored in semantic profile database 108. In order to perform a search based on a search document 114, the search document 114 is parsed and profiled and the resulting search profile 118 is used by search process 110 to generate queries to search semantic profile database 108. Semantic profile database 108 returns results of those queries to search process 110, which performs additional processing, such as ranking of the results, selection of the results, highlighting of the results, summarization of the results, etc. and forms search results 120, which may be returned to the initiator of the search.

The documents input into system 100, such as documents 112 and search document 114, may be any type of electronic document that includes text or that may be converted to text, or any type of physical document that has been converted to an electronic form that includes text or that may be converted to text. For example, the documents may include documents that are mainly text, such as text or word processor documents, documents from which text may be extracted, such as Hypertext Markup Language (HTML) or eXtensible Markup Language (XML) documents, image documents that include images of text that may be extracted using optical character recognition (OCR) processes, documents that may include mixtures of text and images, such as Portable Document Format (PDF) documents, etc., or any type or format of document from which text may be extracted or that may be converted to text. The present invention contemplates the use of any and all types and formats of such documents.

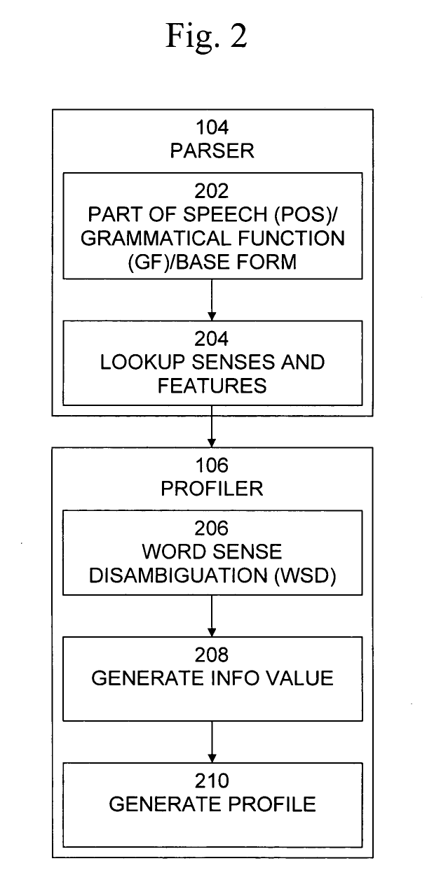

A process of operation of parser 104 and profiler 106, shown in FIG. 1, is shown in FIG. 2. Parser 104 receives input language and performs part of speech (POS)/grammatical function (GF)/base form analysis 202 on the language. POS/GF analysis involves classifying language components based on the role that the language component plays in a grammatical structure. For example, for language components such as words and phrases (terms), each term is classified based on the role that the term plays in a sentence. Parts of speech are also known as lexical categories and include open word classes, which constantly acquire new members, and closed word classes, which acquire new members infrequently if at all.

Parts of speech are dependent upon the language being used. For example, in traditional English grammar there are eight parts of speech: noun, verb, adjective, adverb, pronoun, preposition, conjunction, and interjection. The present invention contemplates application to any and all languages, as well as to any and all parts of speech found in any such language.

Grammatical function (GF) is the syntactic role that a particular term plays within a sentence. For example, a term may be (or be part of) the object, subject, predicate or complement of a clause, and that clause may be a main clause, dependent clause or relative clause, or be a modifier to the subject, object predicate or complement in those clauses.

The words and phrases that may be processed by parser 104 are stored in a token dictionary 105. The input language is tokenized, that is broken up into analyzable pieces, based on the entries in token dictionary 105. Once the POS/GF for a token has been determined, the actual token may be replaced by its base form, as any variation in meaning of the actual token from the base form is captured by the POS/GF information.

Parser 204 also performs a lookup of the senses and features of words and phrases. Word senses relate to the different meanings that a particular word (or phrase) may have. The senses may depend upon the context of the term in a sentence.

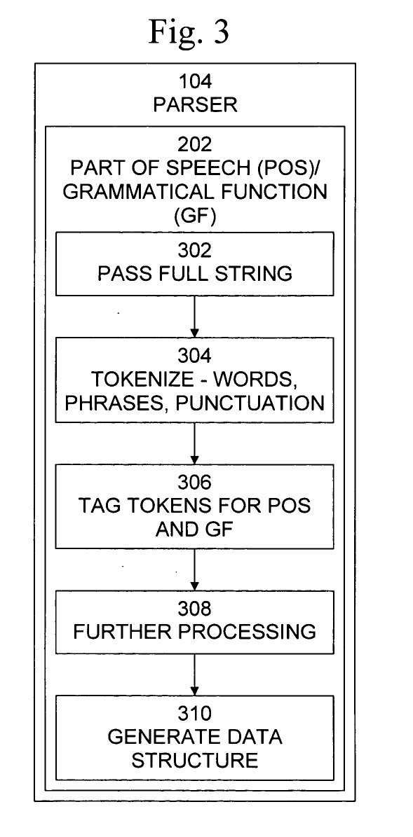

A flow diagram of a process of POS/GF analysis 202, shown in FIG. 2, is shown in FIG. 3. It is best viewed in conjunction with FIG. 1 and with FIG. 16. POS/GF analysis involves classifying language components based on the role that the language component plays in a grammatical structure. POS/GF analysis process 202 begins with step 302, in which full text strings are passed to parser 104. The text strings are extracted from documents 112 or search document 114, which, as described above, may be text documents, word processor documents, text documents derived from optical character recognition of image documents, text documents derived from voice recognition of audio files, etc. Typically, the text strings are sentences, but may be any other division of the document, such as paragraphs, pages, etc. An example 1600 of the parsing of a sentence is shown in FIG. 16. In the example shown in FIG. 16, the sentence to be parsed 1602 is “My associate constructed that sailboat of teak.”

In step 302, parser 104 tokenizes a text string. A token is a primitive block of a structured text that is a useful part of the structured text. Typically, in text documents, each token includes a single word of the text, multi-word phrases, and punctuation. However, tokens may include any other portions of the text, such as numbers, acronyms, symbols, etc. Tokenization is performed using a token dictionary 105, shown in FIG. 1. Token dictionary 105 may be a standard dictionary of words, but preferably, token dictionary 105 is a custom dictionary that includes a plurality of words and phrases, which may be queried for a match by parser 104. For each fragment of the text, parser 104 accesses token dictionary 105 to determine if the fragment of text matches a term stored in the dictionary. If there is a match, that fragment of text is recognized as a token. In the example shown in FIG. 16, matched tokens are shown in column 1604 and unmatched tokens are shown in column 1606. In addition, matches of so-called stop words are shown in column 1608. Stop words are words that are not processed by the parser and profiler and are not included in the semantic profile of the text. Words are typically considered stop words because they likely add little or no information to the text being processed, due to the words themselves, the commonness of usage, etc.

In step 306, parser 104 determines the part of speech (POS) of the token and the grammatical function (GF) of the token, and tags the token with this information. POS/GF analysis involves classifying language components based on the role that the language component plays in a grammatical structure. For example, for language components such as words and phrases, each term is classified based on the role that the term plays in a sentence. Parts of speech are also known as lexical categories and include open word classes, which constantly acquire new members, and closed word classes, which acquire new members infrequently if at all. For some terms, there may be only one possible POS/GF, while for other terms, there may be multiple possible POS/GFs. For each token processed by parser 104, the most likely POS/GF for the token is determined based on the context in which each token is used in the sentence, phrase, or clause being parsed. If a single POS/GF cannot be determined, two or more POS/GFs may be determined to be likely to be related to the token. The token is then tagged with the determined POS/GF information. In the example shown in FIG. 16, POS tags are shown in column 1610 and GF tags are shown in column 1612. As shown in the example, the word “associate” is tagged as being a noun (N) (part of speech) and as a subject (grammatical function). Likewise, constructed is shown as being a verb (V) (POS) and as the main verb (GF).

In step 308, further processing of the tagged tokens is performed. For example, such processing may include identification of clauses, etc. In addition, the actual token may be replaced by the base form of the term represented by the token. In the example shown in FIG. 16, the base forms of words are shown in column 1514. As shown in the example, the word “constructed” is replaced by its base form “construct”.

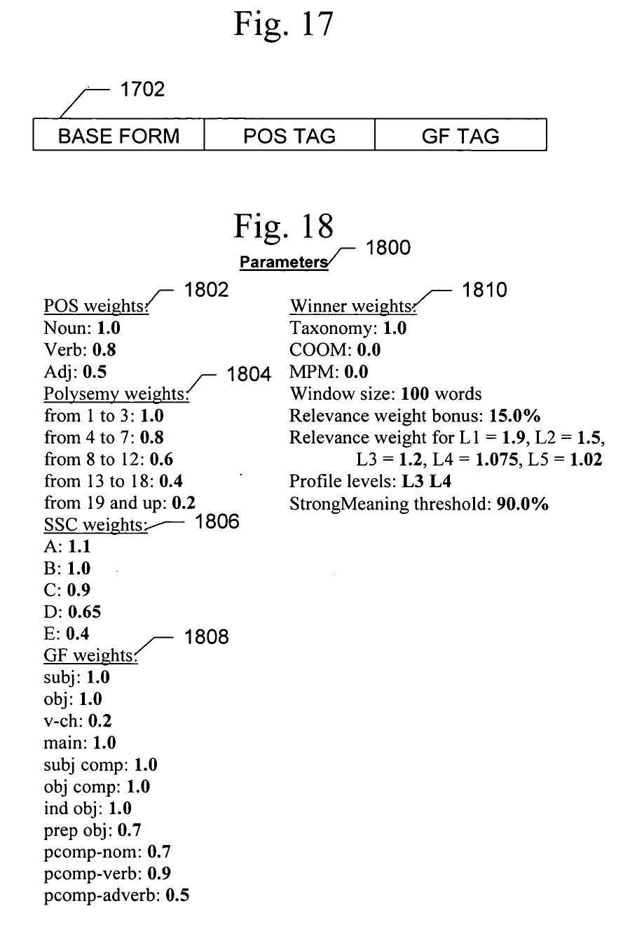

In step 310, a data structure including each token that has been identified and the POS/GF information with which it has been tagged is generated. An example of a format 1700 of this data structure is shown in FIG. 17.

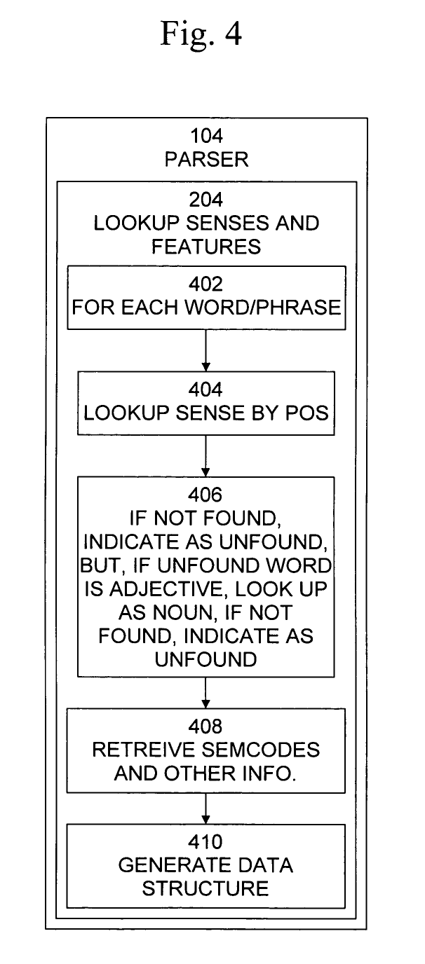

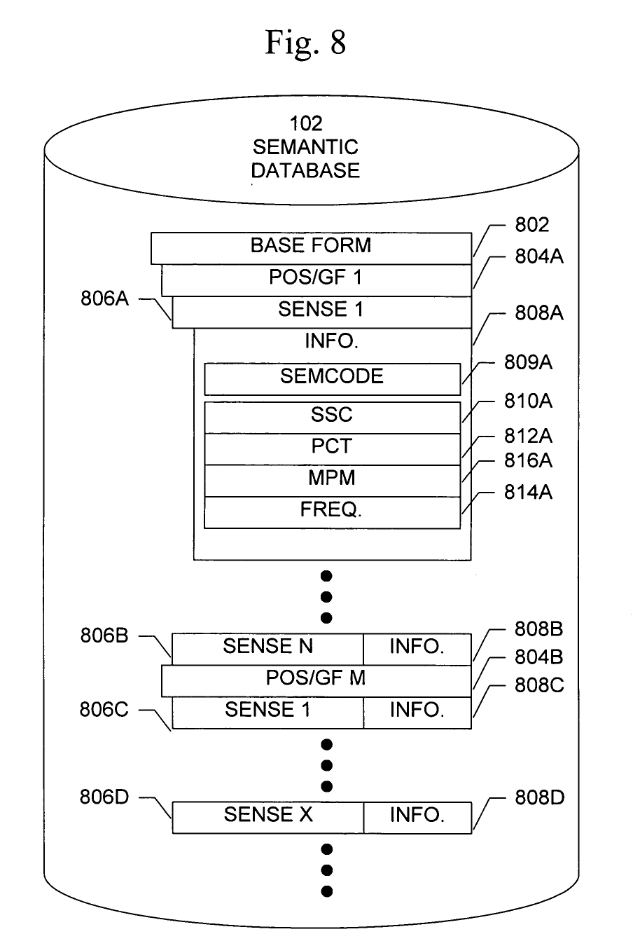

A flow diagram of a process of word sense and feature analysis 204, shown in FIG. 2, is shown in FIG. 4. In step 402, each word (base form) or phrase in the data structure generated in step 310 of FIG. 3 is processed. In step 404, semantic database 102 is accessed to lookup the sense of each term by its tagged part of speech. Turning briefly to FIG. 8, the structure of semantic database 102 is shown. Semantic database 102 is organized using each base form 802 of each term, and the POS/GF information 804B, 804B associated with each base form 802 as the keys to access the database. Associated with each POS/GF are one or more senses or meanings 806A-D that the term may have for the POS/GF.

Associated with each sense 806A-D is additional information 808A-D relating to that sense. Included in the additional information, such as 808A, is the semcode 809A, which is a numeric code that identifies the semantic meaning of each sense of each term for each part of speech. Semcodes are described in greater detail below. Additional information 808A-D may also include Semantico-Syntactic Class (SSC), such as 810A, polysemy count (PCT), such as 812A, and (MPM), such as 816A. The SSC, such as 810A, provides information identifying the position of the term in a semantic and syntactic taxonomy, such as the Semantico-Syntactic Abstract Language, which is described in “The Logos Model: An Historical Perspective,” Machine Translation 18:1-72, 2003, by Bernard Scott, which is hereby incorporated by reference in its entirety. The SSC is described in greater detail below. It is to be noted that this semantic and syntactic taxonomy is merely an example, and the present invention contemplates use with any semantic and syntactic taxonomy.

The PCT, such as 812A, provides information assigning a relative information value based on the number of different meanings that each term has. Terms with more than one part of speech are called syntactically ambiguous and terms with more than one meaning (semcode) within a part of speech are called polysemous. The present invention makes use of the observation that terms with few meanings generally carry more information in a sentence or paragraph than terms with many meanings. Terms with one or just a few different meanings have a low polysemy count and therefore likely have a high inherent information value, since such terms communicate just one or few meanings and are hence relatively unambiguous. The PCT is described in greater detail below. It is to be noted that this polysemy count is merely an example, and the present invention contemplates use with any meaning based measure of relative information value.

The most probable meaning MPM, such as 816A, provides information identifying the sense of each word that is the most likely meaning of the term based on statistics of occurrences of meaning, which is determined based on standard or custom-generated references of such statistics.

In step 404, semantic database 102 is accessed using the term and POS/GF tag associated with the term to retrieve the senses 806A-D and additional information 808A-D associated with that term and POS/GF. In order to access semantic database 102, each term in the data structure generated in step 310 is matched (or attempted to be matched) to one or more entries in semantic database 102. While in many cases, a simple matching is sufficient to retrieve the appropriate entries, in some cases, more sophisticated matching is desirable. For example, single words and noun phrases may be matched by simple matching, but for verb phrases, it may be desirable to perform extended searching over multiple tokens, in order to match verb phrases.

In step 406, fallback processing in the case that the term is not found is performed. If the base form of the term is not found at all in semantic database 102, then that term is indicated as being unfound. However, if the base form of the term is found, but the part of speech with which the term has been tagged is not found, then additional processing is performed. For example, if a term is tagged as being an adjective, but an adjective POS/GF is not found for that term, then parser 104 looks for a noun POS/GF for the term. If a noun POS/GF for the term is found, the senses associated with the noun POS/GF for the term are used. If a noun POS/GF for the term is not found, then the term is indicated as being unfound.

In step 408, for each term that is found in semantic database 102, the information 808A-D associated with each sense of each term is retrieved.

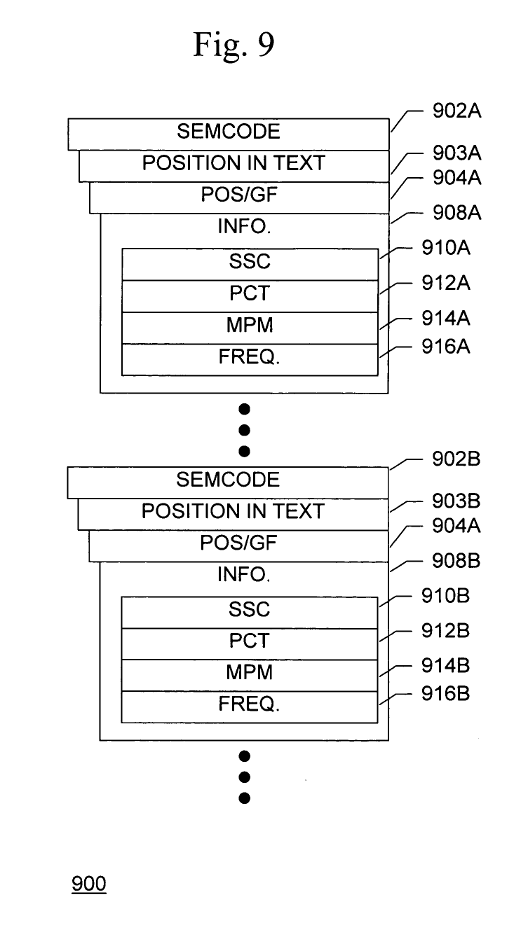

In step 410, a data structure is generated that includes each semcode that has been retrieved, the position of word that the semcode represents in the text being processed, and the retrieved associated additional information. An exemplary format of such a data structure 900 is shown in FIG. 9. For example, data structure 900 may include semcodes, such as 902A and 902B, position information, such as 903A and 903B, POS/GF information, such as 904A and 904B, and additional information, such as 908A and 908B, which includes SSC, such as 910A and 910B, PCT, such as 912A and 912B, MPM, such as 914A and 914B.

Returning to FIG. 4, it is seen that in step 410, a data structure, such as that shown in FIG. 9, is generated.

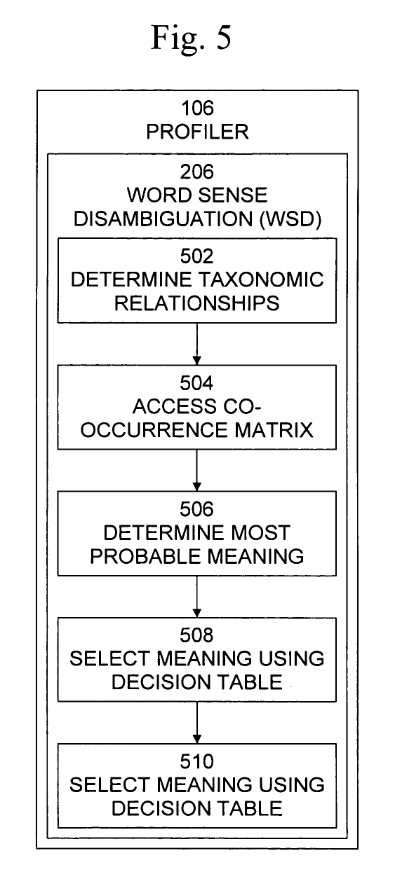

A process of word sense disambiguation 206, shown in FIG. 2, which is performed by profiler 106, is shown in FIG. 5. It is best viewed in conjunction with FIG. 1. Word sense disambiguation (WSD) is the problem of determining in which sense a word having a number of distinct senses is used in a given sentence, phrase, or clause. One problem with word sense disambiguation is deciding what the senses are. In some cases, at least some senses are obviously different. In other cases, however, the different senses can be closely related (one meaning being a metaphorical or metonymic extension of another), and there division of words into senses becomes much more difficult. Due to this difficulty, the present invention uses a number of analyses to select the senses that will be used for further analysis. Preferably, the present invention uses three measures of likelihood that a particular sense represents the intended meaning of each term in a document:
Relationships of senses within the document itself, weighted based on the taxonomic level at which each relationship occurs;
Statistics of co-occurrence of senses at a selected taxonomic level within a large corpus of text; and
The most probable meaning of each sense based on statistics of occurrences of meaning.

Referring to FIG. 1, profiler 106 receives the data structure that was generated by parser 104. Profiler 106 then processes the data structure for each semcode (which represents a term (semcode)) in the data structure. Returning to FIG. 5, in step 502, profiler 106 determines the senses (meanings) of each term (semcode) that is the most likely intended sense based on a determination of taxonomic relationships among the different senses. In particular, profiler 106 determines the taxonomic relationships by determining at what level of a semantic taxonomy hierarchy the different senses of each term (semcode) are related. As described in greater detail below, semantic taxonomies are typically organized in a number of levels, which indicate a degree of association among various meanings. Typically, meanings that are related at some levels of the taxonomy are more closely related, while meanings that are related at other levels of the taxonomy are less closely related. For example, a suitable taxonomic structure may comprise seven levels, levels L0-L6. Level 0 (L0) contains the literal word. Level L1 (L1) contains a small grouping of terms that are closely related semantically, e.g., synonyms, near synonyms, and semantically related words of different parts of speech derived from the same root, such as, e.g., the verb “remove” and the noun “removal.” Each level above L1 represents an increasingly larger grouping of terms according to an increasingly more abstract, common, concept, or group of related concepts, i.e., the higher the level, the more terms are included in the group, and the more abstract the subject matter of the group. Thus, taxonomic levels convey, at various levels of abstraction, information regarding the concepts conveyed by terms and their semantic relatedness to other terms. Thus, profiler 106 determines at what level of a semantic taxonomy the different senses of each word are related, if at all. The Semantico-Syntactic Class (SSC) associated with each sense of a term (semcode) indicates the semantic taxonomy groupings that the term (semcode) belongs to and is used to determine the relationships among the different senses of each word.

It is to be noted that the processing performed by profiler 106 preferably uses the semcodes that are included in the data structure, rather than the actual term represented by the semcode. The use of the semcodes provides a quick and efficient way to determine relationships among words and phrases and greatly increases the performance of profiler 106. Thus, when the profiler is described as determining relationships among terms, or senses of terms, the profiler is processing the semcodes representing those terms, or senses of terms, rather than the terms themselves.

Profiler 106 assigns a taxonomic weight (TW) to relationships among the senses based on the level of the semantic taxonomy at which each sense of a term (semcode) is related to senses of other terms in a document. Preferably, the lower the level at which a sense of a term (semcode) is related to the senses of other terms, the higher the weighting assigned to the relation. This is because terms related at lower levels of the semantic taxonomy are more closely related semantically, thus, assigning a higher weight to such a relation indicates greater semantic closeness. However, the present invention does not exclude a different weighting scheme than that described above. Preferably, the weight values for each taxonomic level are settable, such as with user-level or system-level parameters, which facilitates modification of the weighting scheme.

Preferably, the determination of relationships among senses of terms is done using a moving window of terms based on a selected term for which the most likely meaning is being determined. For example, in order to determine a likely meaning for a selected term, the TW may be based upon taxonomic relationships between one sense of the selected term and all senses of all other terms within the window. This determination may be repeated for each sense of the selected term, in order to determine which sense of the selected term is the most likely meaning. Another term is then selected and the window is moved appropriately. The size of the window is preferably settable, such as with a user-level or system-level parameter. In addition, multi-part windows may be used. For example, the TW may be increased for taxonomic relationships that occur within an inner window (such as two open-class words to the left and right of the selected word) of the overall window. Preferably, the weight values for each window part are settable, such as with user-level or system-level parameters, which facilitates modification of the window scheme. Likewise, it is preferred that only nouns, verbs, and adjectives are used in the determination of relationships among senses of terms. However, the present invention does not exclude the use of other parts of speech in the determination of relationships among senses of terms.

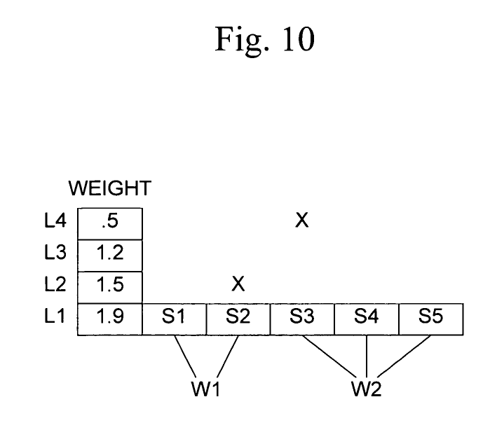

An example of the determination and weighting of relationships among senses of terms is shown in FIG. 10. As shown in FIG. 10, as an example, there are two words in a particular window of terms, words W1 and W2. W1 has two senses, S1 and S2, and W2 has three senses, S3, S4, and S5. The relationships of the senses of these words are determined at a number of levels, from L1, the level that includes the senses themselves, up through levels of decreasing semantic closeness and increasing conceptual generality. The level at which senses are related are weighted based on the semantic closeness represented by the level. Preferably, the levels of greatest semantic closeness are given higher weight than levels of lower semantic closeness. For example, L1 is given the highest weight and L4 is given the lowest weight. In this example, S2 is related to other senses at level L2, so S2 is assigned a weight of 1.5, while S3 is related to other senses at level L4 and is assigned a weight of 0.5.

The output of step 502 is an assignment of weights of taxonomic relationships for each sense of each term (semcode) for each position of a moving window (or windows) of terms in the document. This output may be processed to select a single sense of each term (semcode) that is the most likely to be the intended meaning. For example, the sense having the highest TW may be identified and compared to the sense with the next highest TW. If the highest TW is more than some threshold amount higher than the next highest TW, the sense having the highest TW may be selected as the most likely-meaning based on the TW. If the highest TW is less than some threshold amount higher than the next highest TW, the sense having the highest TW may be selected as possibly being the most likely meaning based on the TW.

In step 504, profiler 106 determines the senses (meanings) of each term (semcode) that is the most likely intended sense based on use of a co-occurrence matrix that is generated based on analysis of a large corpus of text. The co-occurrences are analyzed based on a selected taxonomic level. Preferably, the analysis is performed so as to include co-occurrences of open class words and to exclude stop words and closed class words. The co-occurrences of each sense of each included term (semcode) in the corpus are determined at the selected taxonomic level relative to each other included term (semcode) in the corpus. Statistics or counts of the co-occurrences are generated and used to populate the co-occurrence matrix. It is seen that any corpus of documents may be used for generation of a co-occurrence matrix. Likewise, any taxonomic level or any number of taxonomic levels may be used. The present invention contemplates any and all such selections of corpus and selections of taxonomic levels.

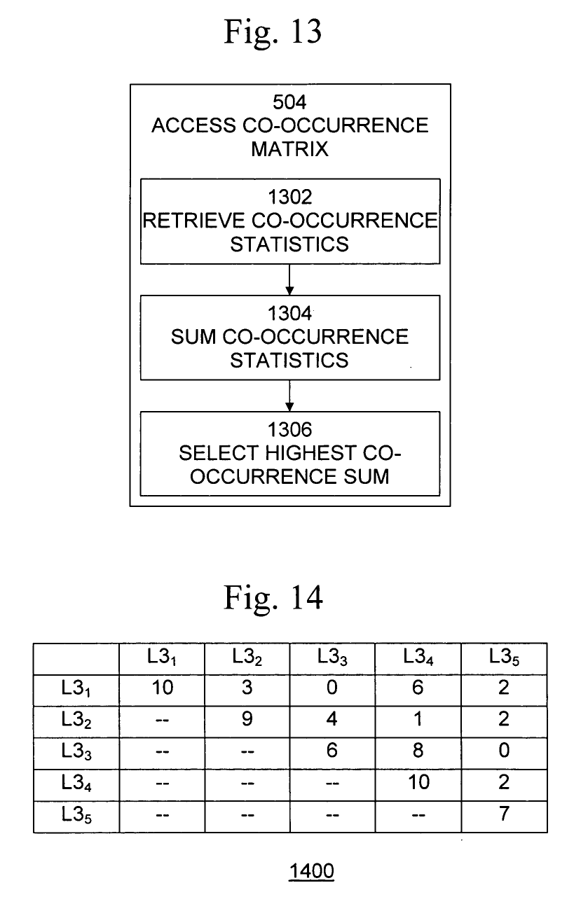

Turning briefly to FIG. 13, the process of step 504 is shown. It is best viewed in conjunction with FIG. 14, which is an example of a co-occurrence matrix. The processing of step 504 begins with step 1302, in which the co-occurrence statistics for the term (semcode) being processed is retrieved. An example of a matrix 1400 of co-occurrence statistics is shown in FIG. 14. In step 1304, starting with terms (semcodes) that are least ambiguous, the co-occurrence statistics are summed for each sense of each term (semcode). Once a word sense has been resolved, other senses of that word are effectively eliminated from this computation, thus paring down the number of co-occurrences that will contribute to word sense resolution. In effect, reduced sense ambiguity is made use of as the remaining unresolved senses are addressed.

In step 1306, the sense that has the highest co-occurrence sum is selected. This is consistent with the principle used in resolving by taxonomic association, i.e., senses with highest overall co-occurrence statistics are like senses that have the highest relevance weight based on taxonomic association.

Returning to FIG. 5, in step 506, the most probable meaning of each sense based on statistics of occurrences of meaning is used to select the most likely senses of each term (semcode) in the document being processed. Each sense of each term (semcode) is looked-up in a table of frequency of occurrence, and the sense having the greatest frequency of occurrence is selected as the most probable meaning of the term (semcode) and is indicated as such. Such frequency tables are available as standard reference works, or they may be custom-generated as desired. The present invention contemplates the use of any and all such frequency tables.

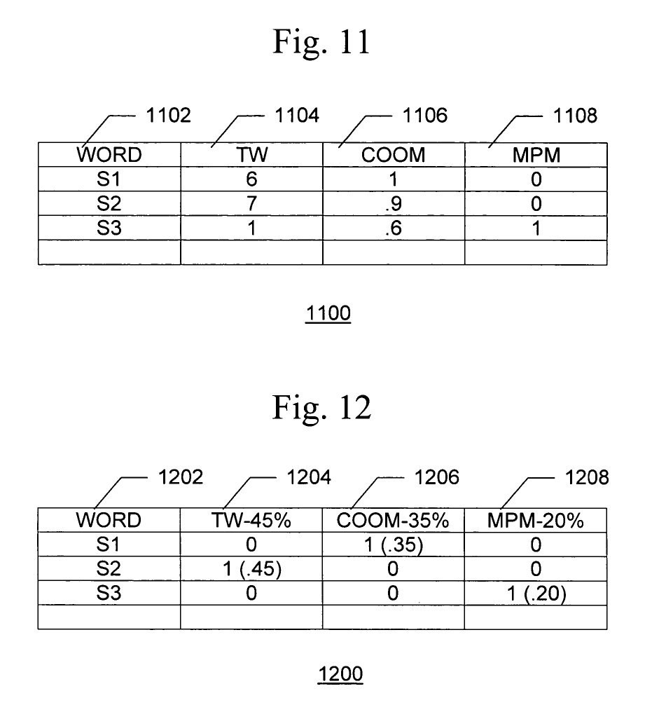

In step 508, the results of steps 502, 504, and 506 are used to select a meaning for each term (semcode) in the document being processed. Preferably, a decision table is used, although any other form of decision logic or decision process is contemplated by the present invention. Examples of decision tables that may be used are shown in FIGS. 11 and 12. In the example shown in FIG. 11, an unnormalized decision table 1100 is shown. Decision table 1100 includes column 1102, which includes the senses of the word being disambiguated, column 1104, which includes the assigned taxonomic weights for each sense from step 502, column 1106, which includes the assigned co-occurrence matrix weights from step 504, and column 1108, which includes the assigned indication of the most probable meaning from step 506. In the example shown in FIG. 11, the taxonomic weight indicates that sense S2 is the most likely meaning, the co-occurrence matrix indicates that sense S1 is the most likely meaning, and the most probable meaning indicates that sense S3 is the most likely meaning. Since, in this instance, there is no clear most likely meaning, the sense indicated as the most probable meaning is selected as the meaning of the word being disambiguated.

In the example shown in FIG. 12, a normalized decision table is shown. In normalized table 1200, the raw weights assigned in steps 502 and 504 are normalized to indicate a most likely meaning selected by those steps. Decision table 1200 includes column 1202, which includes the senses of the word being disambiguated, column 1204, which includes the assigned indication of the most likely meaning based on the taxonomic weights for each sense from step 502, column 1206, which includes the assigned indication of the most likely meaning based on the co-occurrence matrix weights from step 504, and column 1208, which includes the assigned indication of the most probable meaning from step 506. In the example shown in FIG. 12, the columns are not weighted equally, but are assigned different weights as desired to increase the accuracy of the disambiguation process. In this example, the taxonomic weight is assigned 45%, the co-occurrence matrix is assigned 35%, and the most probable meaning is assigned 20%. The taxonomic weight indicates that sense S2 is the most likely meaning, the co-occurrence matrix indicates that sense S1 is the most likely meaning, and the most probable meaning indicates that sense S3 is the most likely meaning. Due to the weighting of the columns, the sense indicated by the taxonomic weight, sense S2, is selected as the meaning of the word being disambiguated.

In step 510, a data structure is generated that includes the semcode of the most likely meaning of each term that was included in the data structure output from step 410 of FIG. 4. This data structure may have a format similar to that shown in FIG. 9, but includes the semcode of the most likely meaning of each term, rather than all semcodes for all terms in the input document.

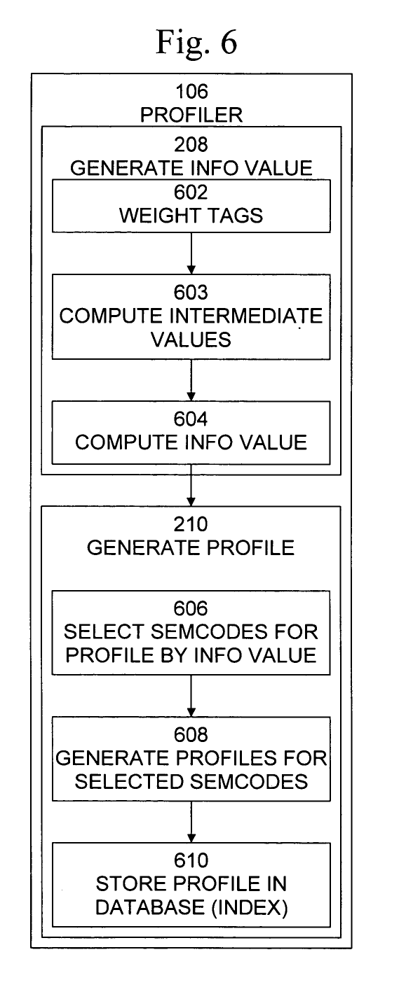

A process of information value generation 206, shown in FIG. 2, which is performed by profiler 106, is shown in FIG. 6. It is best viewed in conjunction with FIG. 1. Process 206 generates an information value for the each meaning (semcode) that is included in the data structure generated in step 510. Process 206 begins with step 602, in which weights are applied to the information associated with each semcode. For example, the SSC 910A, PCT 912A, POS/GF 904A, etc., may be weighted to form weighted values, such as wSSC, wPCT, wPOS, wGF, etc.

In step 603, intermediate values are calculated for each term (semcode) using the weighted values determined in step 602. For example, intermediate values for each semcode may be calculated as follows:

$$PICW = w POS \frac{( w PCT + w SSC )}{2} {\sum }_{i = N}^{N} w GF$$

$$ICW = PICW \times TW$$

where wPOS is the part of speech weight for the semcode obtained from semantic database 102, wPCT is the PCT weight for the semcode obtained from semantic database 102, wSSC the SSC weight for the semcode obtained from semantic database 102, wGF is the grammatical function weight for the semcode obtained from semantic database 102, and TW is the taxonomic weight for the semcode determined in step 502.

In step 604, an information value is calculated based on the intermediate values calculated in step 603. For example, an information value (InfoVal or IV) for each semcode may be calculated as follows:

$$InfoVal = \frac{{\sum }_{i = N}^{N} {ICW}_{i}}{\sum ICW}$$

The information value is a quantitative measure of the amount of information conveyed by each term (semcode) relative to the total information content of a document. Although suitable information values may be calculated as described above, the present invention is not limited to these calculations. Rather, the present invention contemplates any calculations that provide a suitable information value.

A process of semantic profile generation 210, shown in FIG. 2, which is performed by profiler 106, is shown in FIG. 6. It is best viewed in conjunction with FIG. 1. Semantic profile generation involves generating a semantic profile 116 for each document 112 that is processed by system 100. Semantic profile generation process 210 begins with step 606, in which the terms (semcodes) that are to be included in the semantic profile are selected. Typically, the semcodes are selected based on the information value associated with each semcode. For example, those semcodes having an information value greater than or equal to a threshold value may be selected for inclusion in the semantic profile, while those semcodes having an information value less than the threshold value are excluded from the semantic profile.

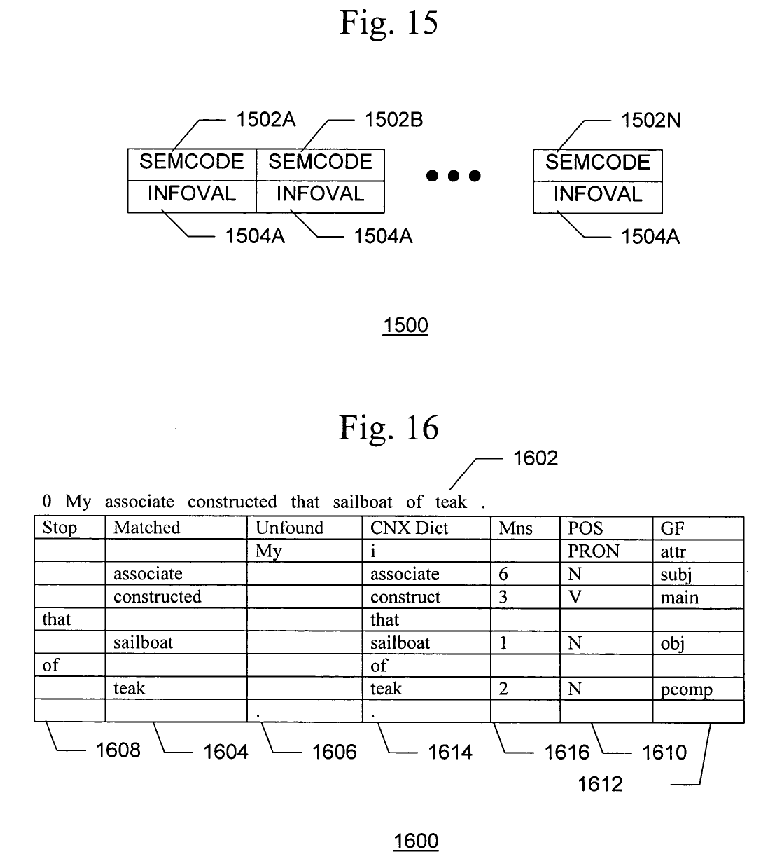

In step 608, the semantic profiles 116 themselves are generated. Preferably, a semantic profile is a vector of information values for the semcodes that were selected for inclusion in the semantic profile. An example of a format 1500 of a semantic profile is shown in FIG. 15. Each semantic profile having format 1500 includes a plurality of semcodes, such as 1502A, 1502B, . . . , 1502N, each with an associated information value, such as 1504A, 1504B, . . . , 1504N. It is to be noted that format 1500 is merely an example of a suitable semantic profile format, and that the present invention contemplates any semantic profile format.

In step 610, semantic profiles 116 are stored in semantic profile database 108, and indexed to provide efficient searching performance. Semantic profile database may be any standard or proprietary database that allows storage and searching for data having a format such as that of profiles 116.

An example of the processing performed by profiler 106, and in particular, the processing performed in step 206, shown in FIG. 5, and in steps 208 and 210, shown in FIG. 6, is shown in FIGS. 18-22. In this example, the document being processed by profiler 106 includes the sentence shown in the example of FIG. 16. Referring to FIG. 18, an example of weighting parameters 1800 that may be set for the profiling process is shown. For example, parameters 1800 include POS weights 1802, Polysemy (PCT) weights 1804, SSC weights 1806, GF weights 1808, and winner or decision weights 1810.

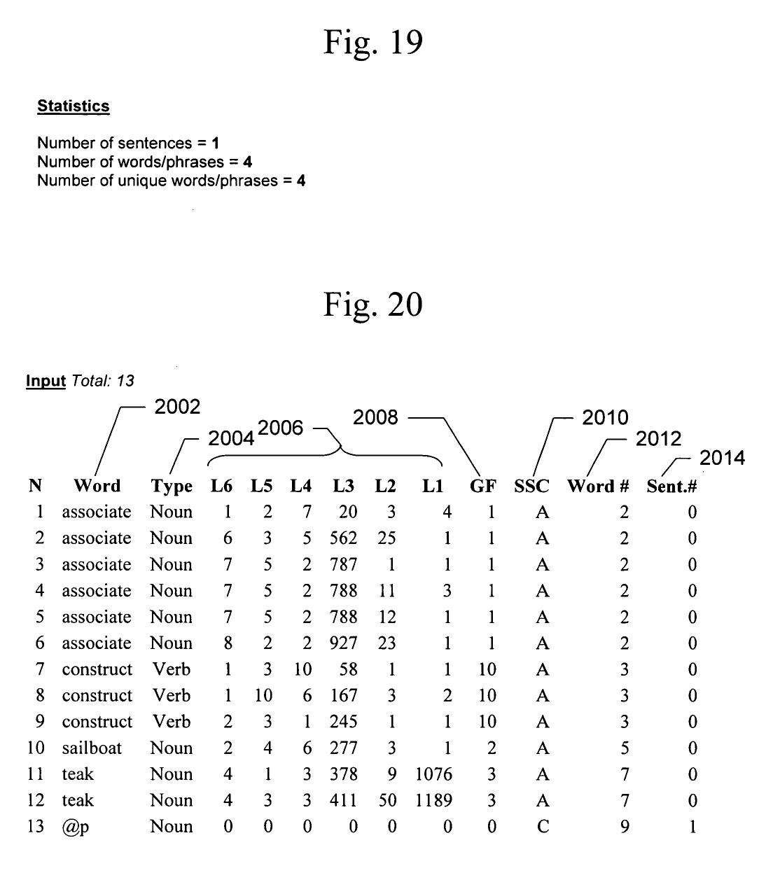

Referring to FIG. 19, some statistics relating to the input sentence are shown. Referring to FIG. 20, an example of data retrieved from semantic database 102 and input to profiler 106 in data structure 900, shown in FIG. 9, is shown. Typically, the format shown is not used as the format of the data structure, but it may be, if desired. The data shown in this example includes the word 2002 to be analyzed, the type or POS 2004 of the word, the semcode 2006 of the sense of the word, broken into the taxonomic levels of the semcode, the GF 2008 of the word, the SSC 2010 of the word, and the location of the word in the document being analyzed by word number 2012 and sentence number 2014.

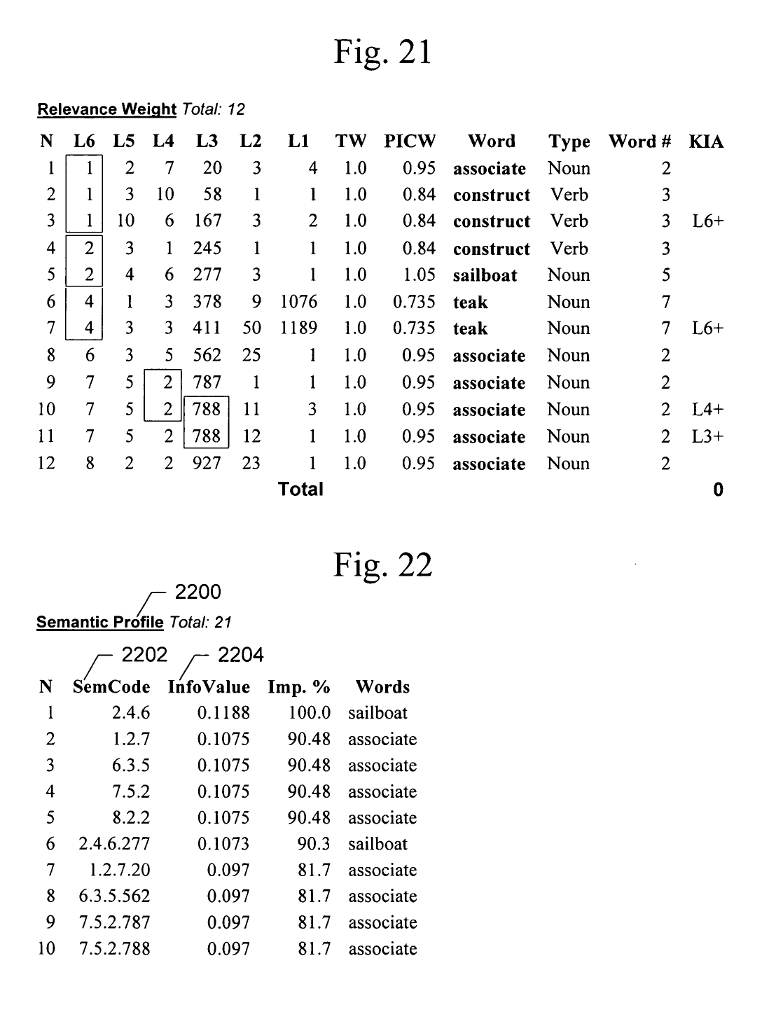

Referring to FIG. 21, an example of output from a process of determination of the taxonomic relationships among the senses, of the words in the exemplary sentence, performed in step 506 of FIG. 5, is shown. For example, some senses of the words related at taxonomic level L6, some relate at taxonomic level L4, and some relate at taxonomic level L3. Also shown are some results of computations of some intermediate values, such as PICW, performed in step 602 of FIG. 6. Finally, referring to FIG. 22, an example of information 2200 included in a semantic profile 116 generated by profiler 106 is shown. Typically, the format shown is not used as the format of the semantic profile, but it may be, if desired. Semantic profile 2200 includes semcodes 2202 and corresponding information values 2204 computed in step 208 of FIG. 6. In addition, information indicating an importance of the sense of the word, as well as the word itself, is shown.

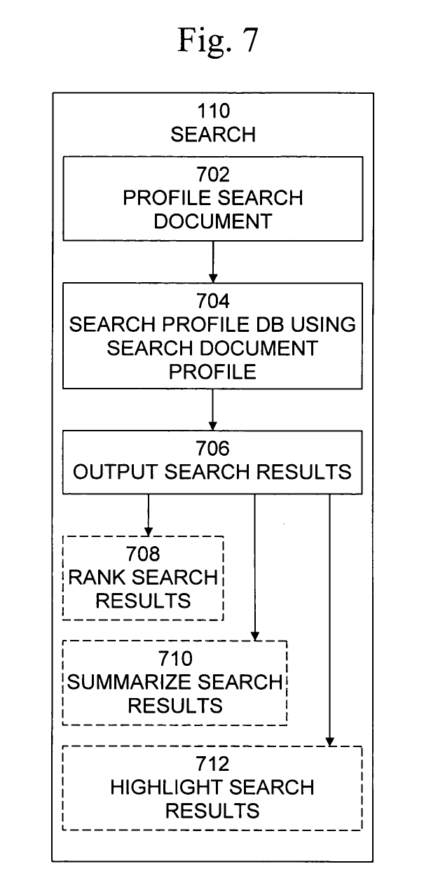

A process 110 of searching based on a search document, shown in FIG. 1, is shown in FIG. 7. It is best viewed in conjunction with FIG. 1. Search process 110 begins with step 702, in which a search document 114 is input and profiled. Search document 110 is parsed by parser 104 and profiled by profiler 106 to generate a search profile 118. The parsing and profiling operations performed by parser 104 and by profiler 106, respectively, are similar to the operations shown in FIGS. 2-6, and need not be described again. The major difference from the operations shown in FIGS. 2-6 is that search profile 118 is not stored in semantic profile database 108, but rather, in step 704, is used as the basis of a search query to search semantic profile database 108.

In step 706, the results 120 of the search performed in step 704 are output and may be presented to the user, or they may be further processed before presentation to the user or to other applications. For example, in step 708, the documents included in search results 120 may be ranked based on their similarity to search document 114. This may be done, for example, by comparing the semantic profile 118 of search document 114 with the profiles of the documents included in search results 120. Additional processing of search results 120 may include generating summaries 710 of the documents included in search results 120 or generating highlighting 712 of the documents included in search results 120.

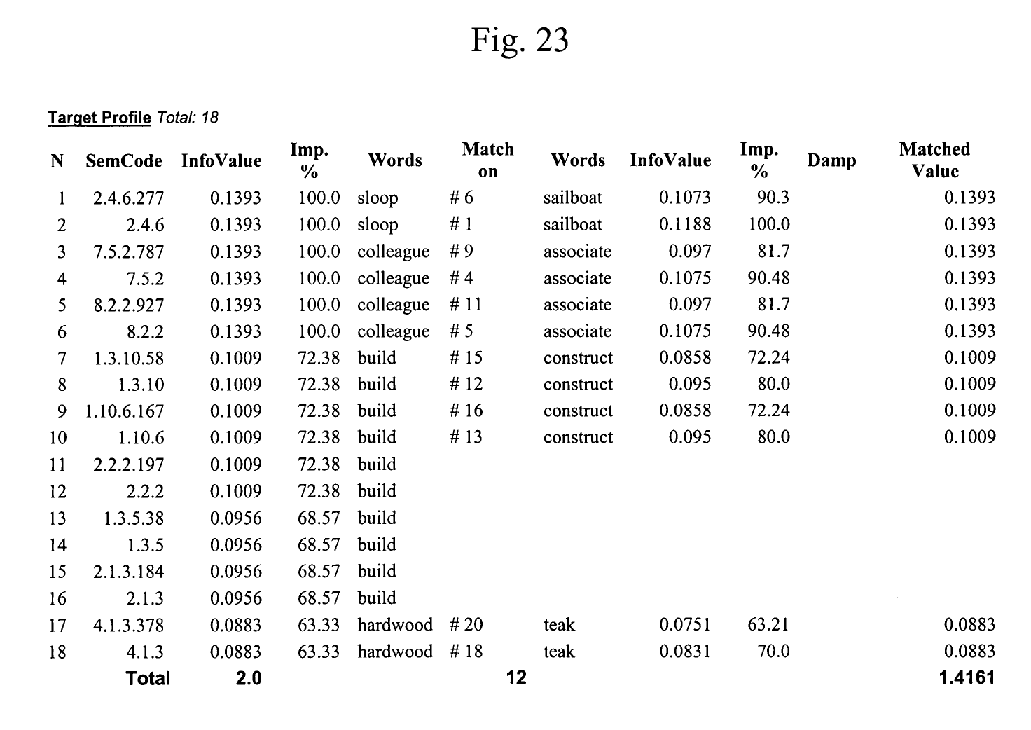

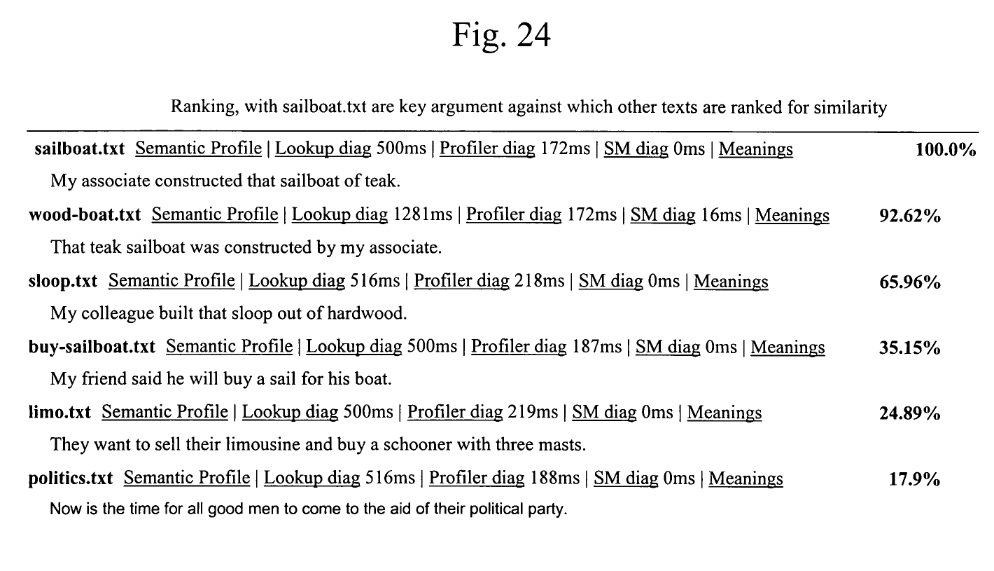

An example of similarity ranking performed in step 708 of FIG. 7 is shown in FIG. 23. In this example, the document being compared includes the sentence used in the example shown in FIG. 16. This document is ranked compared to a document including a sentence having a similar meaning, but no words in common. This may be done, for example, by comparing the semantic profiles of the two documents. As shown in the example, words having similar meanings are matched and ranked by information value, and a total matched value indicating the similarity of the sentences documents is calculated. Referring to FIG. 24, a number of documents are ranked in order of similarity using a similar process.

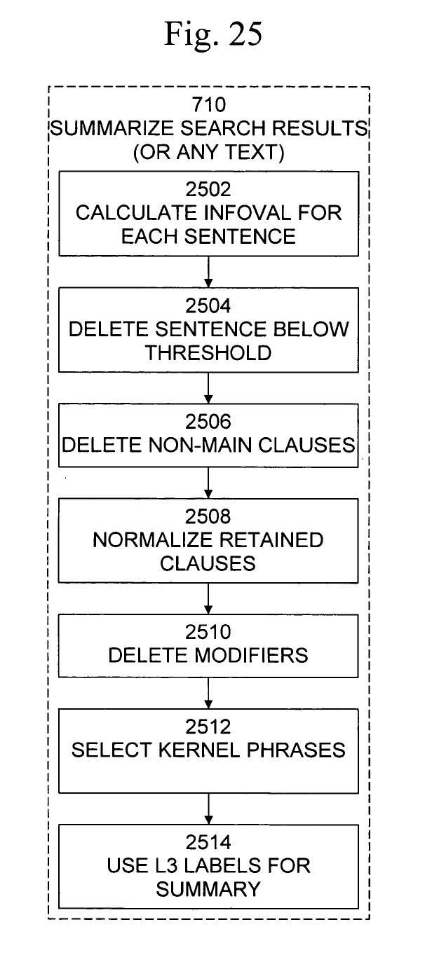

An example of a process of text summarization performed in step 710 of FIG. 7 is shown in FIG. 25. Text summarization may be performed on some or all of the search results output in step 706 of FIG. 7, or text summarization may be performed on any text document, regardless of its source. Process 710 begins with step 2502, in which the information value (IV) for each sentence is calculated. The IV used for text summarization may be calculated as shown above in steps 603 and 604, or the IV used for text summarization may be calculated using other calculations. The present invention contemplates any calculations that provide a suitable IV for text summarization.

The IV for each sentence is calculated by calculating the IV for each word or phrase in the sentence (preferably excluding stop words), then summing the individual word or phrase IVs and dividing by the number of words or phrase for which IVs were summed. In step 2504, sentences having IV below a threshold value are deleted from the consideration for the summary. Such sentences with low IVs add relatively little information to the document. In step 2506, for the retained sentences, non-main clauses that have low IVs (IVs below a threshold) are deleted from the summary. For example, dependent clauses, relative clauses, parentheticals, etc. with low IVs add relatively little information to the document. In step 2508, the retained clauses are normalized to declarative form. For example, the clause “X is modified by Y” is transformed to the declarative form “Y modifies X”.

In step 2510, modifiers of noun phrases (NPs) and verb phrases (VPs) that have low IVs (IVs below a threshold) are deleted. For example, in the VP “intend to purchase”, the modifier “intend to” has a low IV. Upon deletion of the modifier, the phrase becomes simply “purchase”. As another example, in the NP “piece of cake” the modifier “piece of” has a low IV. Upon deletion of the modifier, the phrase becomes simply “cake”. Those phrases remaining at this point are termed “kernel phrases”. In step 2512, all or a portion of the kernel phrases are selected based on an abstraction parameter that controls the quantity of results output by the summarization process. For example, the abstraction parameter may specify a percentage of the kernel phrases to select, in which case the specified percentage of kernel phrases having the highest IVs will be selected. As another example, the abstraction parameter may specify the size of the summary relative to the size of the original document. In this case, the quantity of kernel phrases (having the highest IVs) needed to produce the specified summary size will be selected from among the kernel phrases. The abstraction parameter may be set, for example, by operator input, according to the type of document being analyzed, or by means of a learning system.

In step 2514, the terms present in the kernel phrases are replaced by terms relating to similar concepts selected from the taxonomic hierarchy. In particular, the subject, verb, and object of each kernel phrase are identified and intersections of these terms at a level of the taxonomic hierarchy are determined. The concept labels of the level of the taxonomic hierarchy at which the intersections was determined may then be combined to form sentences that summarize the kernel phrases. For example, subject, verb, and object terms in kernel phrases may be analyzed to determine their intersections at level 3 (L3) of the taxonomic hierarchy. Summary sentences may then be generated that include the labels of the L3 categories at which the intersections occurred. An example of this is shown in the table below:

TABLE 1

| TYPE | SUBJECT | VERB | OBJECT |
|---|---|---|---|
| kernel | administration | is not for | tax hikes |
| kernel | treasurer | argues against | raising taxes |
| kernel | President | will veto | tax bill |
| label | Government | opposes | tax increase |

In this example, the intersection of the subject, verb, and object terms of each kernel phrase is determined and the labels of the L3 categories at which the intersections occurred are presented. For example, “administration”, “treasurer”, and “President” are all terms that intersect at L3 in a category labeled “Government”, “is not for”, “argues against”, and “will veto” are all terms that intersect at L3 in a category labeled “opposes”, and “tax hikes”,“raising taxes”, and “tax bill” are all terms that intersect at L3 in a category labeled “tax increase”. Thus, the sentence, “Government opposes tax increase” forms the summary for the kernel phrases shown.

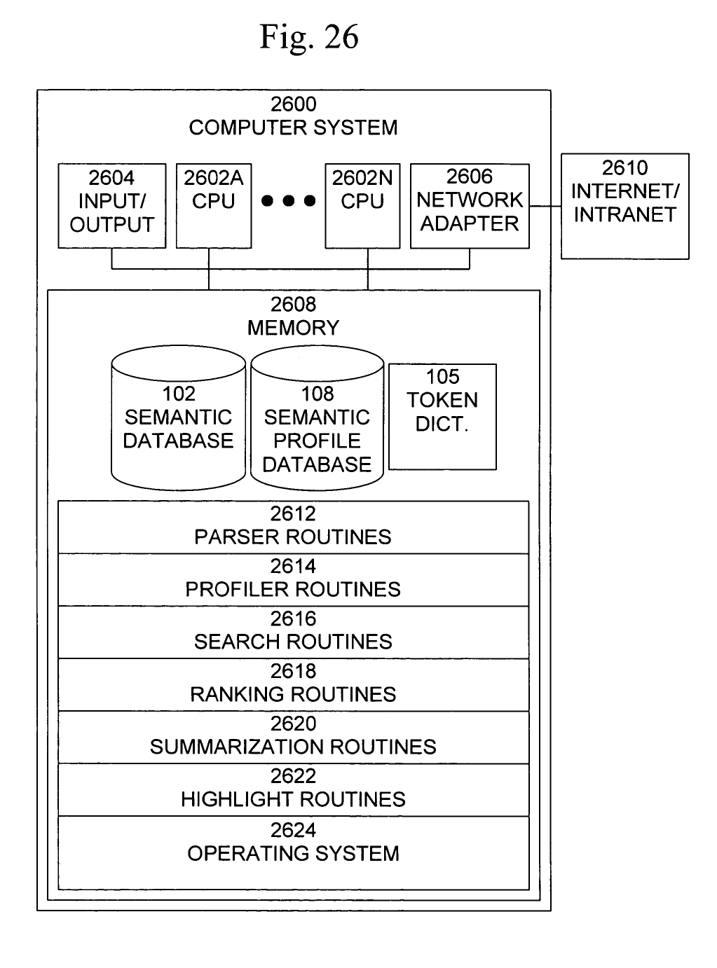

An exemplary block diagram of a computer system 2600, in which the present invention may be implemented, is shown in FIG. 26. System 2600 is typically a programmed general-purpose computer system, such as a personal computer, workstation, server system, and minicomputer or mainframe computer. System 2600 includes one or more processors (CPUs) 2602A-2602N, input/output circuitry 2604, network adapter 2606, and memory 2608. CPUs 2602A-2602N execute program instructions in order to carry out the functions of the present invention. Typically, CPUs 2602A-2602N are one or more microprocessors, such as an INTEL PENTIUM® processor. FIG. 26 illustrates an embodiment in which System 2600 is implemented as a single multi-processor computer system, in which multiple processors 2602A-2602N share system resources, such as memory 2608, input/output circuitry 2604, and network adapter 2606. However, the present invention also contemplates embodiments in which System 2600 is implemented as a plurality of networked computer systems, which may be single-processor computer systems, multi-processor computer systems, or a mix thereof.

Input/output circuitry 2604 provides the capability to input data to, or output data from, database/System 2600. For example, input/output circuitry may include input devices, such as keyboards, mice, touchpads, trackballs, scanners, etc., output devices, such as video adapters, monitors, printers, etc., and input/output devices, such as, modems, etc. Network adapter 2606 interfaces database/System 2600 with Internet/intranet 2610. Internet/intranet 2610 may include one or more standard local area network (LAN) or wide area network (WAN), such as Ethernet, Token Ring, the Internet, or a private or proprietary LAN/WAN.

Memory 2608 stores program instructions that are executed by, and data that are used and processed by, CPU 2602 to perform the functions of system 2600. Memory 2608 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 2608 varies depending upon the function that system 2600 is programmed to perform. However, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 26, memory 2608 includes semantic database 102, semantic profile database 108, token dictionary 105, parser routines 2612, profiler routines 2614, search routines 2616, ranking routines 2618, summarization routines 2620, highlight routines 2622, and operating system 2624. Semantic database 102 stores information about terms included in the documents being analyzed and provides the capability to look up words, word forms, and word senses and obtain one or more meanings that are associated with the words, word forms, and word senses. Semantic profile database 108 stores the generated semantic profiles 116, so that they can be queried. Token dictionary 105 stores the words and phrases that may be processed by parser 104. Parser routines 2612 implement the functionality of parser 104 and, in particular, the processes of steps 202 and 204, shown in FIG. 2. Profiler routines 2614 implement the functionality of parser 106 and, in particular, the processes of steps 206, 208, and 210, shown in FIG. 2. Search routines 2616 implement the functionality of search process 110, shown in FIG. 7. Ranking routines 2618 implement the functionality of ranking step 708, shown in FIG. 7. Summarization routines 2620 implement the functionality of summarization step 710, shown in FIG. 7, and in particular, the process steps shown in FIG. 25. Highlight routines 2622 implement the functionality of highlight step 712, shown in FIG. 7. Operating system 2628 provides overall system functionality.

As shown in FIG. 26, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task, A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention involves identifying each semantic concept of a document as represented by a semcode, and calculating a weighted information value for each semcode within the document based upon a variety of factors. These factors include part-of-speech (POS), semantico-syntactic class (SSC), polysemy count (PCT), usage statistics (FREQ), grammatical function within the sentence (GF), and taxonomic association with other terms in the text (TW). These factors are described in greater detail below.

A Taxonomy of Semantic Codes—Semcodes

The present invention utilizes a structured hierarchy of concepts and word meanings to identify the concept conveyed by each term in a sentence. Any structured taxonomy that correlates concepts with terms in a hierarchy that groups concepts in levels of relatedness may be used. The oldest and most well known taxonomy is Roget's Thesaurus. A taxonomy like Roget's Thesaurus can be viewed as a series of concept levels ranging from the broadest abstract categories down to the lowest generic category appropriate to individual terms or small sets of terms. For example, Roget's Thesaurus comprises seven levels, which may be summarized as levels L0 (the literal term itself) through L6 (the most abstract grouping).

The present invention employs a similar taxonomic hierarchy. In one embodiment, this hierarchy comprises seven levels, levels L0-L6. Level 0 (L0) contains the literal word. Level 1 (L1) contains a small grouping of terms that are closely related semantically, e.g., synonyms, near synonyms, and (unlike the Roget taxonomy) semantically related words of different parts of speech derived from the same root, such as, the verb “remove” and the noun “removal.” Each level above L1 represents an increasingly larger grouping of terms according to an increasingly more abstract, common concept or group of related concepts, i.e., the higher the level, the more terms are included in the group, and the more abstract the subject matter of the group. Thus, taxonomic levels convey, at various levels of abstraction, information regarding the concepts conveyed by terms and their semantic relatedness to other terms.

By assigning a number to each semantic grouping of terms in each taxonomic level, a unique code can thereby be assigned for each meaning of each term populating the taxonomy. At the highest, most abstract level, many terms will share this grouping code. At the lowest, least abstract level, as few as one term may have the grouping code. In effect, when individual codes at all levels of the taxonomy are concatenated, the resultant code summarizes semantic information about each meaning of each term at all the levels of abstraction provided by the taxonomy. This concatenated semantic code is referred to as the “semcode” For example, a taxonomy may comprise 11 codes at level 6, up to 10 codes for any L5 within a given L6, up to 14 codes for any L4 within a given L5, up to 23 codes for any L3 within a given L4, up to 74 codes for any L2 within a given L3, and up to 413 codes for any L1 within a given L2. Thus, in this example, each meaning of each term populating the taxonomy can be uniquely identified by a numeric semcode of the format A.B.C.D.E.F, where: A, representing L6, may be 1 to 11; B, representing L5, may be 1-10; C, representing L4, may be 1 to 14; D, representing L3, may be 001 to 23; E, representing L2, may be 1 to 74; and F, representing L1, may be 1 to 413. Since semcodes uniquely identify each of the particular meanings of a term, semcodes are used to represent the term during analysis to facilitate determination of term meaning and relevance within a document. This distribution of semcode elements in this example is illustrated below.

TABLE 2

| | |
|---|---|
| A | (L6) = 1 to 11 (total number of L6 codes is 11) |
| B | (L5) = 1 to 10 (total number of L6 + L5 codes is 43) |
| C | (L4) = 1 to 14 (total number of L6 + L5 + L4 codes is 183) |
| D | (L3) = 1 to 23 (total number of L6 + L5 + L4 + L3 codes is 1043) |
| E | (L2) = 1 to 74 |
| | (total number of L6 + L5 + L4 + L3 + L2 codes is 11,618) |
| F | (L1) = 1 to 413 |
| | (total number of L6 + L5 + L4 + L3 + L2 + L1 codes is 50,852) |

Total number of semcodes in the exemplary taxonomy: 263,358

An example of a suitable taxonomy for the present invention is based upon the 1977 Edition of Roget's International Thesaurus. This taxonomy has been substantially modified to apply the same semantic categories to multiple parts of speech, i.e., nouns, verbs and adverbs are assigned the same value (Roget's Thesaurus separates verbs, nouns and adjectives into different, part-of-speech-specific semantic categories). Certain parts of speech have no semantic significance and in this example have been removed from the taxonomy, e.g., all adverbs, prepositions, conjunctions, and articles (e.g., “quickly,” “of;” “but,” and “the”). These words may be useful for parsing a sentence but are otherwise treated as semantically null “stop words.” Additionally, new terms, properly encoded, may be added to the current population of terms, and new concepts may be added to the taxonomy.

The Roget taxonomy may also be further modified to include a supplemental, semantico-syntactic ontology, as in the present example. Words and phrases populating the taxonomy may also be assigned lexical features to which parametric weighting factors may be assigned by the processor preparatory to analysis. These features and modifications are more fully described below.

The top-level concepts in a taxonomy suitable for use by the present invention may not provide very useful categories for classifying documents. For example, a exemplary taxonomy may employ top level (i.e., L6) concepts of: Relations, Space, Physics, Matter, Volition, Affections, etc. This level may be useful to provide a thematic categorization of documents. However, one aspect of the present invention is to determine whether a document is more similar in terms of the included concepts to another document than to a third document, and to measure the degree of similarity. This similarity measurement can be accomplished regardless of the topic or themes of the documents, and can be performed on any number of documents.

While stop words need not be included in the taxonomy, such words in a document or query may be useful to help resolve ambiguities of adjacent terms. Stop words can be used to invoke a rule for disambiguating one or more terms to the left or right. For example, the word “the” means that the next word (i.e., the word to the right) cannot be a verb, thus its presence in a sentence can be used to help disambiguate a subsequent term that may be either a verb or a noun.

Substituting or using semcodes in place of the terms represented by the semcodes facilitates the semantic analysis of documents by a computer. For example, the broad, general relatedness of two terms can be quickly observed by comparing their semcodes starting with the first digit, representing L6 of the taxonomy. The further to the right in the semcode in which there is a match, the more closely related the terms are semantically. Thus, the semcode digits convey semantic closeness information with no further need to look up other values in a table. Semcodes provide a single, unified means whereby the semantic distance between all terms and concepts can be readily identified and measured. This ability to measure semantic distance between concepts is important to inter-document similarity measures, as well as to the process of resolving meanings of terms and calculating their relative importance to a text.

An example of a taxonomic analysis of three principal meanings of the word “sound” is provided below. As the tables below illustrates, the noun “sound” may be noise (Table 2), a geographic feature (Table 3) or a medical instrument (Table 4) (This example does not include other meanings, such as the verb “sound” as in to measure depth, or the adjective “sound” as in “of sound mind”).

TABLE 3

| | |
|---|---|
| L6 | SENSATION (5) |

| | |
|---|---|
| L5 | HEARING (6) |

| | |
|---|---|
| L4 | Sound (2) |

| | |
|---|---|
| L3 | SOUND (450) |

| | |
|---|---|
| L2 | sound (1) |

| | |
|---|---|
| L1 | 1 |
| Word Type | Noun |
| Word | sound |

TABLE 4

| | |
|---|---|
| L6 | MATTER (4) |

| | |
|---|---|
| L5 | INORGANIC MATTER (2) |

| | |
|---|---|
| L4 | Liquids (3) |

| | |
|---|---|
| L3 | INLET, GULF (399) |

| | |
|---|---|
| L2 | inlet (1) |

| | |
|---|---|
| L1 | 7 |
| Word Type | Noun |
| Word | sound |

TABLE 5

| | |
|---|---|
| L6 | VOLITION (7) |

| | |
|---|---|
| L5 | CONDITIONS (2) |

| | |
|---|---|
| L4 | Health (3) |

| | |
|---|---|
| L3 | THERAPY (689) |

| | |
|---|---|
| L2 | medical and surgical instrument (36) |

| | |
|---|---|
| L1 | 99 |
| Word Type | Noun |
| Word | sound |

This example illustrates an important advantage of using semcodes provided by a proper taxonomy for analyzing the meaning of terms, instead of the literal terms themselves—terms with different meanings reflecting different, concepts will have completely different (i.e., non-overlapping) semcodes. Thus, the semcode identifies the particular concept intended by the term in the sentence, while the term itself may be ambiguous. This encoding of semantic information within an identifier (i.e., semcode) for the various meanings of a term thus facilitates resolution of the term's appropriate meaning in the sentence, and sorting, indexing and comparing concepts within a document, even when the terms themselves standing alone are ambiguous. Referring to the example of “sound” above, it can be seen that without semantic context it is not possible for a computer to determine whether the noun “sound” refers to noise, a body of water, a medical instrument or any of the other meanings of “sound.” Semcodes provide this context. For example, in the phrase “hear sounds,” one meaning (semcode) of “hear” and one meaning (semcode) of “sounds” share common taxonomic codes from L6 to L4, a circumstance not shared by other meanings of “sound.” Thus, by using the context of other semcodes in the document, it becomes possible for the processor to resolve which of the meanings (semcodes) of “sound” applies in the given sentence.

While a unique semcode corresponds to each term's meaning in the taxonomy and can be used as a replacement for a term, the entire semcode need not be used for purposes of analyzing documents and queries to determine semantic closeness. Comparing semcode digits at higher taxonomic levels allows for richer, broader comparisons of concepts (and documents) than is possible using a keyword-plus-synonym-based search. Referring to the foregoing example of “sound” in the sense of a medical instrument (semcode. 7.2.3.689.36.99), another word such as “radiology,” sharing just L6-L3 of that code (i.e., 7.2.3.689) would allow both terms to be recognized as relating to healing, and a term sharing down to L2, such as “scalpel,” would allow two such terms to be recognized as both referring to medical and surgical instruments. Depending upon the type of analysis or comparison that is desired, semcodes may be considered at any taxonomic level, from L1 to L6. The higher the level at which semcodes are compared, the higher the level of abstraction at which a comparison or analysis is conducted. In this regard, L6 is generally considered too broad to be useful by itself.

All semcodes, along with their associated terms, senses, and additional information, are stored in semantic database 102. As one skilled in the computer arts will appreciate, semantic database 102 may utilize any of a variety of database configurations, including for example, a table of stored meanings keyed to terms, or an indexed data file wherein the index associated with each term points to a file containing all semcodes for that term. An example of a data structure for semantic database 102 is illustrated in FIG. 8. However, the present invention contemplates the use of any database architecture or data structure.

Weighting Factors

The present invention employs a series of weighting factors for (1) disambiguating parts of speech and word senses in a text; (2) determining the relative importance of resolved meanings (i.e., semcodes); (3) preparing a conceptual profile for the document; (4) highlighting most relevant passages within a document; and (5) producing a summarization. The calculation of information value and relevance based upon weighting factors for the senses of a term is an important element of the present invention. These weights enable a computer to determine the sense of a term, determine the information value of these senses, and determine which term senses (i.e., particular semcode) best characterize the semantic import of a text.

Weighting factors are of two kinds; (1) those relating to features of a term (term) and its possible meaning (semcode) independent of context, and (2) those relating to features of a term or meaning (semcode) which are a function of context. The former feature type include weights for part-of-speech, polysemy, semantico-syntactic class, general term and sense frequency statistics, and sense co-occurrence statistics The latter feature type includes weights for grammatical function, taxonomic association, and intra-document frequency. These weighting factors are described more fully below. Weighting factor values may alternatively vary nonlinearly, such as logarithmically or exponentially. In various embodiments, the weighting factors may be adjusted, for example, parametrically, through learning, by the operator or other means.

Part-of-Speech Weights

Semantic database 102 may include a data field or flag, such as 804A, to indicate the part or parts of speech associated with each sense of a word (semcode). Ambiguous words may have multiple part-of-speech tags. For example, the word “sound” may have tags for noun (in the sense of noise), for verb (in the sense of measuring depth) and as adjective (in the sense of sound health) In this regard, however, a particular semcode may be associated with more than one part of speech, because the taxonomy may use the same semcode for the noun, verb and adjective forms of the same root. For example “amuse,” “amusement,” and “amusing” may all be assigned the same semcode associated with the shared concept. This should be distinguished from the example of the word “sound” above where the noun for noise, the verb for measuring, and the adjective for good are not related concepts, and therefore are assigned different semcodes.

Weighting factors may also be assigned to parts of speech (POS) to reflect their informational value for use in calculating document concept profiles and document summarizations. For example, nouns may convey more information in a sentence than do the verbs and adjectives in the sentence, and verbs may carry more information than do adjectives. A non-limiting example of POS weights that may be assigned to terms is shown in the following table.

TABLE 6

| POS | Weight |
|---|---|
| Noun | 1.0 |
| Verb | 0.8 |
| Adjective | 0.5 |

Like other weighting factors and parameters used in the present invention, the POS weights may be adjusted to tailor the analysis to different types of texts or genre. Such adjustments may be made, for example, parametrically, by operator input, according to the type of document being analyzed, or by means of a learning system.

Within the present invention it is anticipated that the POS weights may be adjusted to match the genre of the documents being analyzed or the genre of documents in which a comparison/search is to be conducted. For example, a number of POS weight tables may be stored, such as for technical, news, general, sports, literature, etc., that can be selected for use in the analysis or comparison/search. The POS weight table may be adjusted to reflect weights for proper nouns (e.g., names). The appropriate table may be selected by the operator by making choices in a software window (e.g., by selecting a radio button to indicate the type of document to be analyzed, compared or searched for). Appropriate POS weights for various genres may be obtained by statistically analyzing various texts, hand calculating standard texts and then adjusting weights until desired results are obtained, or training the system on standard texts. These, and any other mechanism for adjusting or selecting POS weights are contemplated by the present invention.

Polysemy Count Weights

Many terms have multiple different meanings. Terms with more than one part of speech are called syntactically ambiguous and terms with more than one meaning (semcode) within a part of speech are called polysemous. The present invention makes use of the observation that terms with few meanings generally carry more information in a sentence or paragraph than terms with many meanings. An example of a term with many meanings is “sound” and an example of a term with only one meaning is “tuberculosis.” The presence of “tuberculosis” in a sentence generally communicates that the sentence unambiguously concerns or is related to this disease. In contrast, a sentence containing “sound” may concern or relate to any of 34 different concepts based upon the various parts of speech, meanings and associated concepts in the example taxonomy. Thus, other terms must be considered in order to determine whether “sound” in a sentence concerns noise, a body of water, determining depth, a state or quality, or any of the other concepts encompassed by “sound.” In other words, the concept conveyed by “sound” in a sentence has many possible syntactic and semantic interpretations that must be disambiguated based upon other terms in the sentence and/or other contextual information. Consequently, the “polysemy count” of “sound” is high and its inherent information content is low.

The “polysemy count weight” (wPCT) is a weighting factor used in the present invention for assigning a relative information value based on the number of different meanings that each term has. The polysemy count and the polysemy count weighting factor are in inverse relation, with low polysemy counts translating to high polysemy count weights. As the preceding paragraph illustrates, terms with one or just a few different meanings have a low polysemy count and are therefore assigned a high polysemy count weight indicative of high inherent information value, since such terms communicate just one or few meanings and are hence relatively unambiguous. In contrast, terms with many different meanings have a high polysemy count and are therefore assigned a low polysemy count weight, indicative of low inherent information value and high degree of ambiguity, since such terms by themselves communicate all their meanings and additional context must be considered in order to determine the concepts communicated in the sentence. Thus, the word “tuberculosis,” with only one meaning, is assigned the highest polysemy count weight, and “sound” with many meanings is assigned a relatively low polysemy count weight.

The polysemy count weighting factor may be assigned using a look up table or factors directly associated with terms populating a taxonomy. An example of a polysemy weighting factor table is provided the table below in which a step function of weights are assigned based upon the number of meanings of a term.

TABLE 7

| PolysemyCount Range Attribute | Value |
|---|---|
| 1 to 3 | 1.0 |
| 4 to 7 | 0.8 |
| 8 to 12 | 0.6 |
| 13 to 18 | 0.4 |
| 19 and above | 0.2 |

Semantico-Syntactic Codes, Classes, and Weights

Developers of machine translation technologies recognized that the meaning of a term in a given sentence depends upon its semantic associations within that sentence as well as its syntactic (grammatical) function. Natural language exhibits immense complexity due in part to this interplay of semantics and syntax in sentences. While humans easily master such complexities, their presence poses formidable barriers to computer analysis of natural language. To cope with such complexity, the present invention employs a system of semantico-syntactic codes assigned to terms. These semantico-syntactic codes capture the syntactic implications of a term's semantics, and thus help in reducing syntactic ambiguity during analysis of a text. For example, consider the two phrases “gasoline pump” and “pump gasoline.” It is clear to a human that the term “pump” has entirely different syntactic function in each phrase. To enable a computer to decide that “pump” is a verb, not a noun, in “pump gasoline”, the invention will make use of the “mass noun” semantic-syntactic code assigned to “gasoline.” One of the properties of a “mass noun” is that the noun can be the object of a verb despite its singular form. This is not true of “count” nouns, e.g., in the phrase “pump meter,” the term “pump” would not be allowed as a verb where the “count” noun “meter” is singular.

An arrangement of the terms of a language in an hierarchical, semantico-syntactic ordering may be regarded as an ontology or taxonomy. An example of such an ontology is the Semantico-Syntactic Abstract Language developed by the inventor at Logos Corporation for the Logos Machine Translation System, and which has been further adapted for the present invention. The Semantico-Syntactic Abstract Language is described in “The Logos Model: An Historical Perspective,” Machine Translation 18:1-72, 2003, by Bernard Scott, which is hereby incorporated by reference in its entirety. The Semantico-Syntactic Abstract Language (SAL) reduces all parts of speech to roughly 1000 elements, referred to as “SAL codes.” This SAL taxonomy focuses on how semantics and syntax intersect (i.e., on the syntactic implications of various semantic properties, as was seen in the example, above).

An additional use of the SAL codes in the present invention concerns assignment of a relative information value to terms of a document. For this purpose, the SAL codes have been modified to form a Semantico-Syntactic Class (SSC), each member of which makes a different weight contribution to the calculation of a term's information value. For example, consider the phrase “case of measles.” Intuitively, one recognizes that in this phrase, “measles” carries inherently higher information value than does the word “case.” The different Semantico-Syntactic Classes and their associated weights assigned to “case” and “measles” in the present invention allows the system to compute lower information values for “case” and higher values for “measles.” In this example, “case” is an ‘Aspective’ type noun in the SAL ontology, which translates to Class E in the SSC scheme of the present embodiment, with the lowest possible weight. “Measles” in the SAL ontology is a “Condition” type noun which translates to Class A in the SSC scheme, with the highest possible weight. Thus, the SSC weight contributes significantly to determining relative information values of terms in a document. Other examples of “Aspective” nouns that translate into very low SSC weights are “piece” as in “piece of cake,” and “row” as in “row of blocks.” In all these examples, the words “case”, “piece” and “row” all convey less information in the phrase than the second noun “measles”, “cake” and “blocks”. Thus, “Aspective” nouns are a class that are assigned a lower Semantico-Syntactic class weighting factor.

The Semantic-Syntactic Class (SSC) weight is also useful in balancing word-count weights for common words that tend to occur frequently. For example, in a document containing dialog, like a novel or short story, the verb “said” will appear a large number of times. Thus, on word count alone, “said” may be given inappropriately high information value. However, “said” is a Semantico-Syntactic Class E word and thus will have very low information value as compared to other words in the statement that was uttered. Thus, when the Semantico-Syntactic Class weighting factors are applied, the indicated information value of “said” will be reduced compared to these other words, despite its frequency.

As shown in FIG. 8, the SSC, such as 812B, for each term is stored in semantic database 102. An example of weights for the various SSC classes is 1806, shown in FIG. 18. Like other weighting factors and parameters used in the present invention, the SSC weights may be adjusted to tailor the analysis to different types of texts or genre. Such adjustments may be made, for example, parametrically, by operator input, according to the type of document being analyzed, or by means of a learning system.

Word and Concept Frequency Statistics and Weights.

The frequency at which terms (words/phrases) and concepts (semcodes) appear both in general usage and in a document being analyzed convey useful data regarding the information value of the term or concept. The present invention takes advantage of such frequency statistics in computing the information value of terms and concepts. Frequency statistics are considered under three aspects: (1) frequency of terms and concepts (semcodes) in general usage; (2) frequency of terms and concepts (semcodes) in a given document; (3) the statistical relationship between concepts considered in (1) and (2). In the following discussion, “terms” refer exclusively to open-class words and phrases, such as nouns, verbs, and adjectives; “concepts” refer to their respective semcodes.

Concerning frequency in general usage, the present invention assumes that there is an inverse relationship between frequency of a term or concept in general usage and its inherent information value. For example, the adjectives “hot” and “fast” are common, frequently occurring terms, and thus provide information of less value compared to the more infrequent “molten” and “supersonic.” Thus, the relative frequency of a term or concept in general usage can be used in assigning a weighting factor in developing the information value of the associated semcodes.

Concerning frequency within a given document, the present invention assumes there is a direct relationship between the frequency of a term in a particular document and the information value of term to that document For example, a document including the word “tuberculosis” a dozen times is more likely to be more concerned with that disease than is a document that mentions the word only once. Accordingly, computation of the informational value of “tuberculosis” to the document must reflect such frequency statistics. In sum, the frequency of a term or semcode in a document conveys information regarding the relevance of that term/semcode to the content of the document. Such semcode frequency information may be in the form of a count, a fraction (e.g., number of times appearing/total number of terms in the document), a percentage, a logarithm of the count or fraction, or other statistical measure of frequency.

A third statistical frequency weighting factor to be used in computing the information value of a term or concept (semcode) may be obtained by comparing the frequency of the term or concept in a document with the frequency of the term or concept in general use in the language or genre. For example, in a document where the word “condition” appears frequently and the word “tuberculosis” appears far less frequently, the conclusion could be falsely drawn that ‘condition’ was the informationally more valuable term of the two. This incorrect conclusion can be avoided by referring to real-world usage statistics concerning the relative frequency of these two words. Such statistics would indicate that the word ‘tuberculosis’ occurs far more infrequently than does “condition,” allowing the conclusion that, even if the word “tuberculosis” appears only once or twice in a document, its appearance holds more information value than the word “condition.” Thus, weights based on relative real-world usage statistics may help offset the misleading informational value of more frequently occurring terms.

Comparative frequency measures require knowledge of the average usage frequency of terms in the language or particular genre or domain of the language. Frequency values for terms can be obtained form from public sources, or calculated from a large body of documents or corpus. For example, one corpus commonly used for measuring the average frequency of terms is the Brown Corpus, prepared by Brown University, which includes a million words. Further information regarding the Brown Corpus is available in the Brown Corpus Manual available at: <http://helmer.aksis.uib.no/icame/brown/bcm.html>. Another corpus suitable for calculating average frequencies is the British National Corpus (BNC), which contains 100 million words and is available at http://www.natcorp.ox.ac.uk/.

This term-frequency weighting factor (term statistics weight or wTSTAT) may be assigned to a term or calculated based upon the frequency statistics by any number of methods known in the art, including, for example, a step function based upon a number range or fraction above or below the average, a fraction of the average (e.g., frequency in document/frequency in corpus), a logarithm of a fraction (e.g., log(freq. in document/frequency in corpus)), a statistical analysis, or other suitable formula. For example, wTSTAT may be derived from the classic statistical calculation:
wTSTAT=tf*idf, Eq.1
where tf is the frequency of the term in a given document; and
idf is the inverse frequency of the term in general use.

Comparable resources for global statistics on semcode frequency, as opposed to statistics on term frequency, are not generally available, and may be developed inductively as a by-product of the present invention and its ability to resolve semantically ambiguous terms to a specific meaning (semcode).

Instead of general-usage frequency measures, term/semcode frequency statistics may be calculated for a particular set of documents, such as all documents within a particular library or database to be indexed and/or searched. Such library-specific frequency statistics may provide more reliable indicators of the importance of particular terms/semcodes in documents within the library or database

Concept Co-Occurrence Statistics

An additional use of general language statistics in the present invention concerns semcode co-occurrence statistics. Semcode co-occurrence statistics here refer to the relative frequency with which each of the concepts (semcodes) in the entire taxonomy co-occurs with each of the other concepts (semcodes) in the taxonomy. Statistical data on semcode co-occurrence in general, or in specific genre or domains, may typically be maintained in a two dimensional matrix optimized as a sparse matrix. Such a semcode co-occurrence matrix may comprise semcodes at any taxonomic level, or, to keep matrix size within more manageable bounds, at taxonomic levels 2 or 3 (L2 or L3). For example, a co-occurrence matrix maintained at L3 may be a convenient size, such as approximately 1000 by 1000.

Statistical data on the co-occurrence of semcodes may be used by the present invention to help resolve part-of-speech and term-sense ambiguities. For example, assume that a given term in a document has two unresolved meanings (semcodes), one of which the invention must now attempt to select as appropriate to the context. One of the ways this is done in the present invention is to consider each of the two unresolved semcodes in relationship to each of the semcodes of all other terms in the document, and then to consult the general co-occurrence matrix to determine which of these many semcode combinations (co-occurrences) is statistically more probable. The semcode combination (semcode co-occurrence) in the document found to have greater frequency in the general semcode co-occurrence matrix will be given additional weight when calculating its information value, which value in turn provides the principal basis for selecting among the competing semcodes. Thus, general co-occurrence statistics may influence one of the weighting factors used in resolution of semantic ambiguity.

Statistics on the co-occurrence of semcodes are not generally available, but may be compiled and maintained inductively through the on-going processing of large volumes of text. To collect these co-occurrence statistics, the analysis of corpora is at the level of term meaning, where such statistics are not generally available and no reliable automated method has been established for this purpose.

Term and semcode frequency analysis is also useful when assessing the relevance of documents to a search query or comparing the relatedness of two documents. In such comparisons, the co-occurrence of terms or semcodes provides a first indication of relevance or relatedness based on the assumption that documents using the same words concern the same or similar concepts. A second indication of relevance or relatedness is the relative information value of shared concepts. As stated, one possible weighting factor in calculating information value is local and global frequency statistics.

Frequency analysis may be applied to semcodes above level 1 (L1) to yield a frequency of concepts statistic. To calculate such statistics, semcodes for the terms in the corpus must be determined at the level (e.g., L2 or L3). In essence, this weighting factor reflects the working assumption that concepts appearing more frequently in a document than in common usage are likely to be of more importance regarding the subject matter of the document than other concepts that occur at average or less than average frequency. Using such semcode frequency statistics may resolve the small-number (sparseness) problem associated with rarely used synonyms of common concepts. Semcode-frequency weighting factors may be calculated in a manner similar to term frequency as discussed above.

As a further alternative, various combinations of term frequency and L1, L2 or L3 semcode frequency weighting factors may be applied. Applying weighting factors for both term frequency and semcode (i.e., concept) frequency at one or more of these levels would permit the resulting information value to be useful for disambiguating the meanings (semcodes) of terms, for profiling a document, for comparing the relatedness of two documents for ranking purposes, and for document summarization. In some genres, such as technical, scientific and medical publications, frequency statistics may be most useful for identifying important concepts, particularly when a word reflects a term of art or a formal descriptor of a particular concept.

Grammatical Function Weights

Not all terms of a text have equal information value to the semantic import of that text. One feature that further serves to differentiate the information value of a term in a text is the term's grammatical function. Grammatical function (GF) is the syntactic role that a particular term plays within a sentence. For example, a term may be (or be part of) the object, subject, predicate or complement of a clause, and that clause may be a main clause, dependent clause or relative clause, or be a modifier to the subject, object predicate or complement in those clauses. Further, a weighting factor reflecting the grammatical function of a word is useful in establishing term information value for purposes of profiling, similarity-ranking and summarization of texts.

A GF tag may be assigned to a term to identify the grammatical function played by a term in a particular sentence. Then, a GF weight value may be assigned to terms to reflect the grammatical information content of the term in the sentence based upon its function. During the processing of a document according to an embodiment of the present invention, parser 104 will add a tag to each term to indicate its grammatical function in the parsed sentence (step 202 of FIG. 2).

After parsing, a GF weight may be assigned to the term, such as by looking the GF tag up in a data table and assigning the corresponding weighting factor. For example, GF weights may be assigned to the grammatical functions parametrically, by learning, by operator input, or according to genre. The relative information content for various grammatical functions may vary based upon the genre (e.g., scientific, technical, literature, news, sports, etc.) of a document, so different GF weights may be assigned based upon the type of document in order to refine the analysis of the document. As another example, the GF weight value may be assigned by a parser at the time the sentence is analyzed and the grammatical function is determined.

Polythematic Segmentization

Many short documents discuss a single topic (examples might include recent weather patterns, relief efforts for hurricanes, the price of tea in China, and so on). The semantic profile for each such document can fruitfully be compared to other documents' profiles. However, if a document discusses multiple unrelated topics (e.g., a recipe for stroganoff and climate change in Midwestern states), then a single semantic profile has diminished utility in matching similar profiles. Colloquially we say the profile becomes muddy. For the purposes of effective use of all technologies based on the semantic profiler, we want to impose what we call the monothematic constraint, namely that all profiles should represent a single theme, or topic. The polythematic segmentizer is the mechanism by which we impose that constraint.

The polythematic segmentizer will identify changes in topics within a document, and create a separate semantic profile for each distinct topic. The Polythematic Segmentizer is a software program that divides a document into multiple themes, or topics. To accomplish this it must be able to identify sentence and paragraph breaks, identify the topic from one sentence/paragraph to the next, and detect significant changes in the topic. The output is a set of semantic profiles, one for each distinct topic.

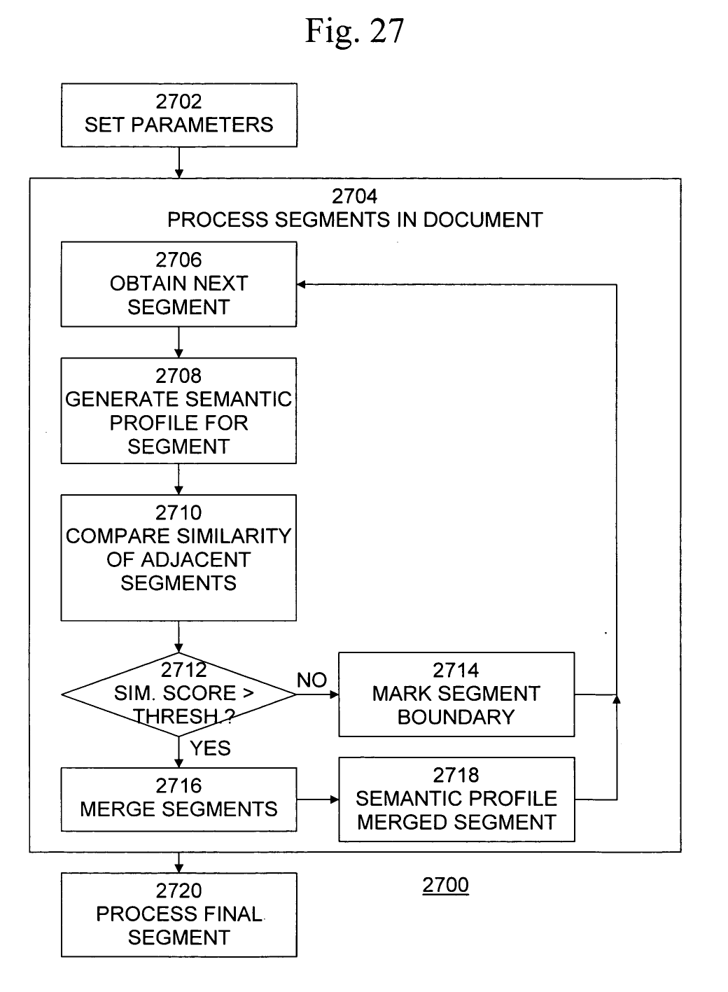

An example of a process 2700 of polythematic segmentization is shown in FIG. 27. Process 2700 begins with step 2702, in which the parameters of the process are set. Such parameters may include:
A minimum segment size, such as a number of sentences, words, and/or unique words needed to form a segment. For example, a segment size ma be set as X sentences (default=3), Y words (default=30), and Z unique words (default=25).
Paragraph mode vs. Sentence mode—whether the segments are to be formed in paragraph mode or sentence mode. In Paragraph Mode, a candidate segment is defined as a sequence of 1 or more paragraphs that meet the minimum segment size requirements. If the paragraph does not meet these minimum size requirements, the segment is expanded to include the next paragraph in the text. If the end of the text is reached before meeting the minimum size requirements, the segment is complete. In Sentence mode, a candidate segment is defined as a sequence of 1 or more sentences that meet the minimum segment size requirements. If the sentence does not meet these minimum size requirements, the segment is expanded to include the next sentence in the text. If you reach the end of the text before meeting the minimum size requirements, you're done. If the end of the text is reached before meeting the minimum size requirements, the segment is complete.
Reserved threshold—a level of similarity between semantic profiles of segments that are being compared. For example, the reserved threshold may be a percentage (0-100) (default=15%)

Profile Levels (L0-L6)—levels at which the segments are to be semantically profiled.

In step 2704, the segments in the document (whether sentences or paragraphs) are processed. Step 2704 involves an iterative process including steps 2706-2718. In step 2706, the next segment is obtained. In step 2708, a semantic profile is generated for the segment. In step 2710, the similarity of adjacent segments is determined and compared. That is, the similarity of the current segment and the immediately previous segment is compared. Of course, at the beginning of the process, the second segment must be obtained and profiled before it can be compared to the first segment. In step 2712, it is determined whether the similarity determined in step 2710 is greater than or equal to a threshold, termed the reserved threshold. If the determined similarity of the two segments is below the reserved threshold, then the two segments are judged to be significantly dissimilar and the process continues with step 2714, in which a segment boundary is marked between the two segments. The process then loops back to step 2706, in which the next segment is obtained.

If the determined similarity of the two segments is greater than or equal to the reserved threshold, then the two segments are judged to be similar (relating to a single topic) and the process continues with step 2718, in which the two segments are merged to form a single, combined segment. The process then loops back to step 2706, in which the next segment is obtained. In this case, the next segment is compared to the merged segment formed in step 2718.

When the end of the document is reached, that is, the next segment is the final segment, the process continues with step 2720. In step 2720, if the similarity between the current segment and the last segment is below the reserved threshold, and if the last segment does not satisfy the minimum segment size requirements, then the criteria for determining whether the current and next (last) segment are split into two or combined into one. For example, the similarity metric may be modified according to:

$${similarity}^{′} = similarity * [ \frac{( {c}_{i} / {c}_{j} ) + ( {u}_{i} / {u}_{j} )}{2} ] ,$$

where c is the word count, u is the unique word count, i is the current segment and j is the final segment. The modified similarity (similarity′) is substituted for regular similarity in the comparison to the reserved threshold, and the determination of whether to merge or split the two segments is made based on the modified similarity.

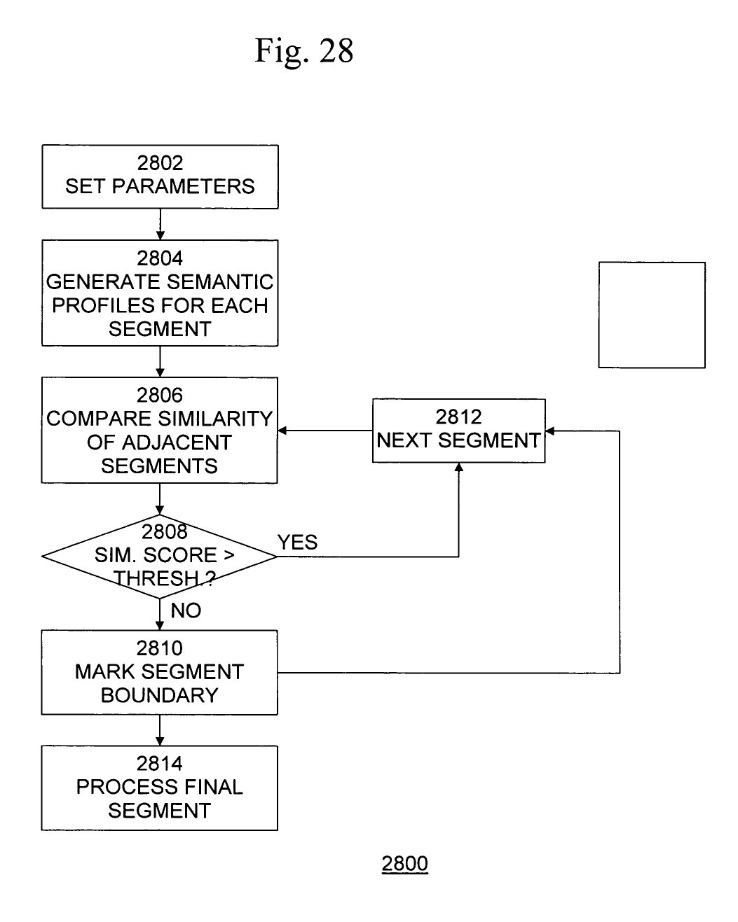

Another example of a process 2800 of polythematic segmentization is shown in FIG. 28. Process 2800 begins with step 2802, in which the parameters of the process are set. Such parameters may include parameters similar to those described for step 2702, shown in FIG. 27. In step 2804, a semantic profile is generated for each segment in the document. In step 2806, the similarity of, adjacent segments is determined and compared. That is, the similarity of each segment and the immediately adjacent segment is compared. In step 2808, it is determined for each pair of adjacent segments, whether the similarity determined in step 2806 is greater than or equal to a threshold, termed the reserved threshold. If the determined similarity of the two segments is below the reserved threshold, then the two segments are judged to be significantly dissimilar and the process continues with step 2810, in which a segment boundary is marked between the two segments. The process then continues with step 2706, in which the next segment is obtained, and loops back to step 2806.

If the determined similarity of the two segments is greater than or equal to the reserved threshold, then the two segments are judged to be similar (relating to a single topic), so no segment boundary is marked. The process continues with step 2812, in which the next segment is obtained, and loops back to step 2806.

When the end of the document is reached, that is, the next segment is the final segment, the process continues with step 2814, in which final segment processing similar to that described for step 2720, shown in FIG. 27, is performed.

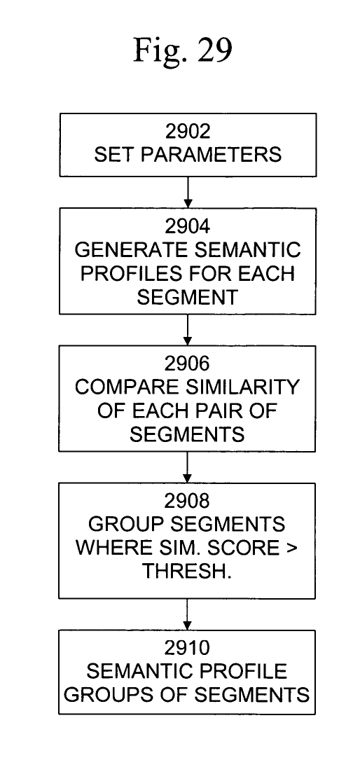

Another example of a process 2900 of polythematic segmentization is shown in FIG. 29. Process 2900 begins with step 2902, in which the parameters of the process are set. Such parameters may include parameters similar to those described for step 2702, shown in FIG. 27. In step 2904, a semantic profile is generated for each segment in the document. In step 2906, the similarity of each pair of segments in the document is determined and compared. That is, the similarity of each segment and each other segment in the document is compared. In step 2908, segments are grouped based on their similarity. That is, each segment for which the similarity to another segment is greater than or equal to the reserved threshold is grouped with other similar segments. In step 2910, for each group, a new semantic profile is generated by combining all segments in a group into a new, single segment. (A segment may now contain non-contiguous sub-segments).

Similarity Metrics

There are a wide variety of similarity metrics in use today. As the preferred representation of a semantic profile is a vector of information values, a similarity metric useful in the present invention should be applicable to vectors. For example, there are two kinds of metrics that work on vectors. There are those designed for binary vectors (where each cell has a value of zero or one), and those designed for vectors of real values. Examples of measures intended for binary vectors are matching, dice, jaccard, overlap, and cosine. As semantic profiles are vectors of InfoVals, which are real values, metrics designed for vectors of real values are applicable to the present invention. For example, there are versions of the dice, jaccard and cosine metrics that can also be applied to real vectors, which are sometimes referred to as extended measures (extended dice, extended jaccard, extended cosine). These may be adapted to apply to vectors of information values.

For example, one useful measure that may be applied to vectors of information values is the cosine measure, which is an effective means of computing similarity between two term vectors. A standard cosine measure computes the magnitude of a vector using the Pythagorean Theorem applied to counts of terms. In the present invention, however, the magnitude of a vector is computed using the Pythagorean Theorem applied to the information value (InfoVal) of semcodes. A standard cosine measure computes the dot product by multiplying the sum of counts for terms in each vector. In the present invention the dot product is computed by multiplying the sum of InfoVals for semcodes in each vector. InfoVal is a better indicator of the relevance of a term in a document than term frequency. (This applies to all uses of similarity measurements between semantic profiles, not just in the polythematic segmentizer.)

For example, in the present invention, the magnitude of a vector is defined as

$$‖ V ‖ = \sqrt{{\sum }_{i = 1}^{n} {x}^{2}} ,$$

and the dot product between two vectors is defined as:

$${V}_{1} \cdot {V}_{2} = {\sum }_{i = 1}^{n} {x}_{i} {y}_{i} ,$$

where x,y are information values. Given this, the following similarity metrics that utilize information values for semcodes may be defined:

$$extended cosine similarity metric = \frac{{V}_{1} \cdot {V}_{2}}{‖ {V}_{1} ‖ \times ‖ {V}_{2} ‖} , \\ extended dice similarity metric = \frac{{V}_{1} \cdot {V}_{2}}{( {\sum }_{i = 1}^{n} {x}_{i}^{2} + {\sum }_{i = 1}^{n} {y}_{i}^{2} ) / 2} , \\ and$$

$$extended jaccard similarity metric = \frac{{V}_{1} \cdot {V}_{2}}{( {\sum }_{i = 1}^{n} {x}_{i}^{2} + {\sum }_{i = 1}^{n} {y}_{i}^{2} ) - ( {V}_{1} \cdot {V}_{2} )} .$$

It is to be noted that these similarity metrics are merely examples of suitable metrics. The present invention may apply any of a number of other similarity metrics to the realm of information value. For example, the information radius is another suitable metric. The present invention contemplates the use of any similarity metric that uses the information value of the semcodes in a document, rather than simply using frequencies of the terms in the document.

Examples of additional suitable similarity metrics also include the z-method, the L₁ norm, and the iv.idiv, which are described below.

In the z-method, the similarity metric is defined as:

$$z - method similarity metric = {\sum }_{i = 1}^{n} ( {a}_{i} + {b}_{i} ) \times {c}_{i} , \\ \text{where}$$

$${a}_{i} = max ( {x}_{i} , {y}_{i} ) , \\ {b}_{i} = min ( {x}_{i} , {y}_{i} ) , \\ {c}_{i} = \frac{{b}_{i}}{{a}_{i}} ,$$

and x, y are information values.

The z-method uses a damping function, for which there are two variants:

Variant 1: if (aᵢ+bᵢ)×cᵢ≧aᵢ, then substitute bᵢ for (aᵢ+bᵢ)×cᵢ

Variant 2: if (aᵢ+bᵢ)×cᵢ≧aᵢ, then substitute

$$\frac{( {a}_{i} + {b}_{i} )}{2}$$

for (aᵢ+bᵢ)×cᵢ

In the L₁ norm, L₁ is defined as:

$${L}_{1} = {\sum }_{i} \vert {p}_{i} - {q}_{i} \vert ,$$

and the similarity metric is defined as:

$${L}_{1} norm similarity metric = \frac{1}{2} {L}_{1} ( p , q )$$

where p, q are conditional probabilities of information values between two semantic profiles. Conditional probability is computed as the information value for each semcode in a profile divided by the sum of information values for that profile (p=ivᵢ/Σivₙ, where iv is an information value for a semcode in a profile).

| | profile 1 | profile 2 |
|---|---|---|
| semcode 1 | iv₁ (p₁) | iv₁ (q₁) |
| semcode 2 | iv₂ (p₂) | iv₂ (q₂) |
| semcode 3 | iv₃ (p₃) | iv₃ (q₃) |
| . . . | . . . | . . . |

The iv.idiv method is derived from the tf.idf method. In its simplest conception, the traditional tf.idf algorithm can be represented as:
similarity metric=tf_{t,d}×idfₜ
where tf_{t,d} is the frequency of a term t in a document d, and idfₜ is the number of documents in a collection that a term t occurs in.

The formula in its implementation is modified by weighting (term and document frequency weighting) and normalization factors, and may include other calculations such as “boosting” factors for specific query terms. For example, tf and idf can be weighted logarithmically, such as (1+log(tf_{t,d})) and

$$log ( \frac{N}{{df}_{f}} ) ,$$

respectively.

The iv.idiv approach differs significantly from typical tf.idf approaches in the use of information value, rather than term frequency, as a measure of the saliency of a word in a given document. Information value is a far better indicator of the contribution of individual semcodes to the meaning of a document than a term frequency count.

Traditional tf.idf will typically use a damping function, such as sqrt(tf) or 1+log(tf). The rationale for the damping function is that a document that contains, say, three occurrences of a word is somewhat more important than a document that contains one occurrence, but not necessarily three times as important. However, in the case of information value, relative importance of information values between semantic profiles has already been accounted for, and such a damping function is no longer useful.

The iv.idiv approach, iv.idiv embodies the notion that the weight of a document in a collection can be based upon the information values of the semcodes in that document's semantic profile, compared to the relative distribution of information values for that semcode across the entire collection. Information value is a direct measure of the importance of a semcode in a document, and idv is, by comparison, a measure of the importance of that semcode to documents in the collection generally.

So, the formula for calculating iv.idiv can be represented as such:
similarity metric=iv_{sc,d}×idv_{sc}
where iv_{sc,d} is the information value of a semcode sc in a document d, and idv_{sc} is the value that a semcode sc has across the entire collection. As before, iv and idv can be weighted, and scores normalized, using standard methods.

It is important to note that while the present invention has been described in the context of a fully functioning data processing system, those of ordinary skill in the art will appreciate that the processes of the present invention are capable of being distributed in the form of a computer readable medium of instructions and a variety of forms and that the invention applies equally regardless of the particular type of signal bearing media actually used to carry out the distribution. Examples of computer readable media include storage media such as floppy disc, a hard disk drive, RAM, and CD-ROM's, as well as transmission media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method of determining similarity between portions of text, the method comprising:
generating a semantic profile for at least two portions of text, each semantic profile comprising a vector of values; and
computing a similarity metric representing a similarity between the at least two portions of text using the at least two generated semantic profiles.

2. The method of claim 1, wherein the semantic profile comprising a vector of information values.

3. The method of claim 2, wherein a portion of text comprises a sentence.

4. The method of claim 2, wherein a portion of text comprises a paragraph.

5. The method of claim 2, wherein the similarity metric is computed according to:
$$extended cosine similarity metric = \frac{{V}_{1} \cdot {V}_{2}}{‖ {V}_{1} ‖ \times ‖ {V}_{2} ‖} , \\ where$$
$$‖ V ‖ = \sqrt{{\sum }_{i = 1}^{n} {x}^{2}} , \\ {V}_{1} \cdot {V}_{2} = {\sum }_{i = 1}^{n} {x}_{i} {y}_{i} ,$$
and x,y are information values of segments.

6. The method of claim 2, wherein t the similarity metric is computed according to:
$$extended dice similarity metric = \frac{{V}_{1} \cdot {V}_{2}}{( {\sum }_{i = 1}^{n} {x}_{i}^{2} + {\sum }_{i = 1}^{n} {y}_{i}^{2} ) / 2} , \\ and where$$
$${V}_{1} \cdot {V}_{2} = {\sum }_{i = 1}^{n} {x}_{i} {y}_{i} ,$$
and x,y are information values of segments.

7. The method of claim 2, wherein the similarity metric is computed according to:
$$extended jaccard similarity metric = \frac{{V}_{1} \cdot {V}_{2}}{( {\sum }_{i = 1}^{n} {x}_{i}^{2} + {\sum }_{i = 1}^{n} {y}_{i}^{2} ) - ( {V}_{1} \cdot {V}_{2} )} , \\ where$$
$${V}_{1} \cdot {V}_{2} = {\sum }_{i = 1}^{n} {x}_{i} {y}_{i} ,$$
and x,y are information values of segments.

8. The method of claim 2, wherein the similarity metric is computed according to:
$$z - method similarity metric = {\sum }_{i = 1}^{n} ( {a}_{i} + {b}_{i} ) \times {c}_{i} , \\ where$$
$${a}_{i} = max ( {x}_{i} , {y}_{i} ) , \\ {b}_{i} = min ( {x}_{i} , {y}_{i} ) , \\ {c}_{i} = \frac{{b}_{i}}{{a}_{i}} ,$$
and x, y are information values.

9. The method of claim 8, wherein the similarity metric is further computed according to:
if (aᵢ+bᵢ)×cᵢ≧aᵢ, then substitute bᵢ for (aᵢ+bᵢ)×cᵢ.

10. The method of claim 8, wherein the similarity metric is further computed according to:
if (aᵢ+bᵢ)×cᵢ≧aᵢ, then substitute
$$\frac{( {a}_{i} + {b}_{i} )}{2}$$
for (aᵢ+bᵢ)×cᵢ.

11. The method of claim 2, wherein the similarity metric is computed according to:
$${L}_{1} norm similarity metric = \frac{1}{2} {L}_{1} ( p , q ) , \\ wherein$$
$${L}_{1} = {\sum }_{i} \vert {p}_{i} - {q}_{i} \vert ,$$
and wherein p, q are conditional probabilities of information values between two semantic profiles computed as an information value for each semcode in a profile divided by a sum of information values for that profile.

12. The method of claim 2, wherein the similarity metric is computed according to:
similarity metric=iv_{sc,d}×idv_{sc},
wherein iv_{sc,d} is an information value of a semcode sc in a document d, and idv_{sc} is
a value that a semcode sc has across an entire collection.

13. A system for determining similarity between portions of text comprising:
a processor operable to execute computer program instructions;
a memory operable to store computer program instructions executable by the processor; and
computer program instructions stored in the memory and executable to perform the steps of:
generating a semantic profile for at least two portions of text, each semantic profile comprising a vector of values; and
computing a similarity metric representing a similarity between the at least two portions of text using the at least two generated semantic profiles.

14. The system of claim 13, wherein the semantic profile comprising a vector of information values.

15. The system of claim 14, wherein a portion of text comprises a sentence.

16. The system of claim 14, wherein a portion of text comprises a paragraph.

17. The system of claim 14, wherein the similarity metric is computed according to:
$$extended cosine similarity metric = \frac{{V}_{1} \cdot {V}_{2}}{‖ {V}_{1} ‖ \times ‖ {V}_{2} ‖} , \\ where$$
$$‖ V ‖ = \sqrt{{\sum }_{i = 1}^{n} {x}^{2}} , \\ {V}_{1} \cdot {V}_{2} = {\sum }_{i = 1}^{n} {x}_{i} {y}_{i} ,$$
and x,y are information values of segments.

18. The system of claim 14, wherein t the similarity metric is computed according to:
$$extended dice similarity metric = \frac{{V}_{1} \cdot {V}_{2}}{( {\sum }_{i = 1}^{n} {x}_{i}^{2} + {\sum }_{i = 1}^{n} {y}_{i}^{2} ) / 2} , \\ and where$$
$${V}_{1} \cdot {V}_{2} = {\sum }_{i = 1}^{n} {x}_{i} {y}_{i} ,$$
and x,y are information values of segments.

19. The system of claim 14, wherein the similarity metric is computed according to:
$$extended jaccard similarity metric = \frac{{V}_{1} \cdot {V}_{2}}{( {\sum }_{i = 1}^{n} {x}_{i}^{2} + {\sum }_{i = 1}^{n} {y}_{i}^{2} ) - ( {V}_{1} \cdot {V}_{2} )} , \\ where$$
$${V}_{1} \cdot {V}_{2} = {\sum }_{i = 1}^{n} {x}_{i} {y}_{i} ,$$
and x,y are information values of segments.

20. The system of claim 14, wherein the similarity metric is computed according to:
$$z - method similarity metric = {\sum }_{i = 1}^{n} ( {a}_{i} + {b}_{i} ) \times {c}_{i} , \\ where$$
$${a}_{i} = max ( {x}_{i} , {y}_{i} ) , \\ {b}_{i} = min ( {x}_{i} , {y}_{i} ) , \\ {c}_{i} = \frac{{b}_{i}}{{a}_{i}} ,$$
and x, y are information values.

21. The system of claim 20, wherein the similarity metric is further computed according to:
if (aᵢ+bᵢ)×cᵢ≧aᵢ, then substitute bᵢ for (aᵢ+bᵢ)×cᵢ.

22. The system of claim 20, wherein the similarity metric is further computed according to:
if (aᵢ+bᵢ)×cᵢ≧aᵢ, then substitute
$$\frac{( {a}_{i} + {b}_{i} )}{2}$$
for (aᵢ+bᵢ)×cᵢ .

23. The system of claim 14, wherein the similarity metric is computed according to:
$${L}_{1} norm similarity metric = \frac{1}{2} {L}_{1} ( p , q ) , \\ wherein$$
$${L}_{1} = {\sum }_{i} \vert {p}_{i} - {q}_{i} \vert ,$$
and wherein p, q are conditional probabilities of information values between two semantic profiles computed as an information value for each semcode in a profile divided by a sum of information values for that profile.

24. The system of claim 14, wherein the similarity metric is computed according to:
similarity metric=iv_{sc,d}×idv_{sc},
wherein iv_{sc,d} is an information value of a semcode sc in a document d, and idv_{sc} is
a value that a semcode sc has across an entire collection.

25. A computer program product for determining similarity between portions of text comprising:
a computer readable storage medium;
computer program instructions, recorded on the computer readable storage medium, executable by a processor, for performing the steps of
generating a semantic profile for at least two portions of text, each semantic profile comprising a vector of values; and
computing a similarity metric representing a similarity between the at least two portions of text using the at least two generated semantic profiles.

26. The computer program product of claim 25, wherein the semantic profile comprising a vector of information values.

27. The computer program product of claim 26, wherein a portion of text comprises a sentence.

28. The computer program product of claim 26, wherein a portion of text comprises a paragraph.

29. The computer program product of claim 26, wherein the similarity metric is computed according to:
$$extended cosine similarity metric = \frac{{V}_{1} \cdot {V}_{2}}{‖ {V}_{1} ‖ \times ‖ {V}_{2} ‖} , \\ where$$
$$‖ V ‖ = \sqrt{{\sum }_{i = 1}^{n} {x}^{2}} , \\ {V}_{1} \cdot {V}_{2} = {\sum }_{i = 1}^{n} {x}_{i} {y}_{i} ,$$
and x,y are information values of segments.

30. The computer program product of claim 26, wherein t the similarity metric is computed according to:
$$extended dice similarity metric = \frac{{V}_{1} \cdot {V}_{2}}{( {\sum }_{i = 1}^{n} {x}_{i}^{2} + {\sum }_{i = 1}^{n} {y}_{i}^{2} ) \text{/} 2} , and where {V}_{1} \cdot {V}_{2} = {\sum }_{i = 1}^{n} {x}_{i} {y}_{i} ,$$
and x,y are information values of segments.

31. The computer program product of claim 26, wherein the similarity metric is computed according to:
$$extended jaccard similarity metric = \frac{{V}_{1} \cdot {V}_{2}}{( {\sum }_{i = 1}^{n} {x}_{i}^{2} + {\sum }_{i = 1}^{n} {y}_{i}^{2} ) - ( {V}_{1} \cdot {V}_{2} )} , where {V}_{1} \cdot {V}_{2} = {\sum }_{i = 1}^{n} {x}_{i} {y}_{i} ,$$
and x,y are information values of segments.

32. The computer program product of claim 26, wherein the similarity metric is computed according to:
$$z - method similarity metric = {\sum }_{i = 1}^{n} ( {a}_{i} + {b}_{i} ) \times {c}_{i} , where {a}_{i} = max ( {x}_{i} , {y}_{i} ) , {b}_{i} = min ( {x}_{i} , {y}_{i} ) , {c}_{i} = \frac{{b}_{i}}{{a}_{i}} ,$$
and x, y are information values.

33. The computer program product of claim 32, wherein the similarity metric is further computed according to:
if (aᵢ+bᵢ)×cᵢ≧aᵢ, then substitute bᵢ for (aᵢ+bᵢ)×cᵢ .

34. The computer program product of claim 32, wherein the similarity metric is further computed according to:
if (aᵢ+bᵢ)×cᵢ≧aᵢ, then substitute
$$\frac{( {a}_{i} + {b}_{i} )}{2}$$
for (aᵢ+bᵢ)×cᵢ.

35. The computer program product of claim 26, wherein the similarity metric is computed according to:
$${L}_{1} norm similarity metric = \frac{1}{2} {L}_{1} ( p , q ) , wherein {L}_{1} = {\sum }_{i} \vert {p}_{i} - {q}_{i} \vert ,$$
and wherein p, q are conditional probabilities of information values between two semantic profiles computed as an information value for each semcode in a profile divided by a sum of information values for that profile.

36. The computer program product of claim 26, wherein the similarity metric is computed according to:
similarity metric=iv_{sc,d}×idv_{sc},
wherein iv_{sc,d} is an information value of a semcode sc in a document d, and idv_{sc} is a value that a semcode sc has across an entire collection.
